(19) United States
(12) Patent Application Publication
(10) Pub. No.: US 2026/0211292 A1
(43) Pub. Date: Jul. 23, 2026

(54) APPARATUS AND METHOD FOR TRANSFORMING A NOISY RF OSCILLATOR INTO A HIGH PERFORMANCE SIGNAL SOURCE WITH PHOTONIC DELAY-LINE ENABLED CARRIER SUPPRESSION INTERFEROMETRY (CSI) AND SELF-PHASE LOCKING

(71) Applicant: Xiaotian Steve Yao, Las Vegas, NV (US)

(72) Inventor: Xiaotian Steve Yao, Las Vegas, NV (US)

(21) Appl. No.: 19/449,253

(22) Filed: Jan. 14, 2026

Related U.S. Application Data
(60) Provisional application No. 63/745,246, filed on Jan. 14, 2025.

(51) Int. Cl. G02F 1/21; H04B 10/25; H04B 10/50

(52) U.S. Cl. CPC G02F 1/212; G02F 2202/20; H04B 10/25; H04B 10/503

(57) ABSTRACT

This patent document provides a novel scheme to reduce phase noise of various voltage-controlled oscillators (VCOs) in radiofrequency (RF) or microwave ranges by deploying photonic delay-line (PhDL) enabled carrier suppression interferometry (CSI), assisted by self-injection locking (SIL). Applicable VCOs include opto-electronic oscillators.

### PRIORITY CLAIM AND CROSS-REFERENCE TO RELATED APPLICATION

This patent document timely claims priority to and benefits of U.S. Patent Application No. 63/745,246 entitled “Apparatus and method for transforming a noisy RF oscillator into a high performance signal source with photonic delay-line enabled carrier suppression interferometry (CSI) and self-phase locking,” and filed on Jan. 14, 2025, which is incorporated herein by reference in its entirety.

### TECHNICAL FIELD

This patent document relates to techniques and devices for reducing noise in oscillation signals, and more specifically, to techniques and devices for generation of oscillation signals with low phase noise in the radio frequency (RF) and microwave spectral ranges.

### BACKGROUND

Signal sources for generating oscillation signals in the radio frequency (RF) and microwave spectral ranges are voltage controlled oscillators (VCOs) that are widely used electronic components in in various applications, with the trend going towards higher frequencies and lower phase noises in various applications including, e.g., communications¹, radar,² and aerospace.³

### SUMMARY

High frequency low phase noise voltage controlled oscillators for radiofrequency (RF) or microwave signal generation tend to be difficult and expensive to make. This patent document discloses examples of implementations of techniques and devices for reducing noise in oscillation signals, and more specifically, to techniques and devices for using two feedback loops based on a to control a voltage controlled oscillator for generation of oscillation signals with low phase noise in the radio frequency (RF) and microwave spectral ranges.

This patent document provides a novel scheme to reduce phase noise of various voltage-controlled oscillators (VCOs) in radiofrequency (RF) or microwave ranges by deploying photonic delay-line (PhDL) enabled carrier suppression interferometry (CSI), assisted by self-injection locking (SIL). Applicable VCOs include opto-electronic oscillators.

In one embodiment, the disclosed technology can be implemented to provide a device that includes:
a voltage controlled oscillator that includes a first input port to receive a control voltage that controls the voltage controlled oscillator, a second input port to receive an injection oscillation signal, and an output port to output an oscillation signal at a carrier oscillation frequency in response to the control voltage and the injection oscillation signal;
an optical modulator coupled to receive the oscillation signal from the voltage controlled oscillator to modulate light at the carrier oscillation frequency to produce modulated light;
an optical delay element coupled to receive a first portion of the modulated light from the optical modulator to output a first optical signal with a long delay caused by the optical delay element;
a first optical detector coupled to receive the first optical signal output by the optical delay element to produce a first electrical signal;
a second optical detector coupled to receive a second portion of the modulated light from the optical modulator that does not pass through the optical delay element, as a second optical signal to produce a second electrical signal;
an electrical interferometer coupled to receive the first and second electrical signals to cause an interference between the first and second electrical signals to produce a first electrical interferometer output signal representing a destructive interference that suppresses signaling at the carrier oscillation frequency and a second electrical interferometer output signal representing a constructive interference;
a signal mixer coupled to receive the first electrical interferometer output signal representing the destructive interference and the second electrical interferometer output signal representing the constructive interference to output a first feedback signal with an amplitude representing a phase noise of the carrier oscillation signal output by the voltage controlled oscillator with suppression of signaling at the carrier oscillation frequency;
a first feedback loop coupled between the signal mixer and the first input port of the voltage controlled oscillator to receive the first feedback signal to generate the control voltage and to couple the control voltage to the first input port of the voltage controlled oscillator so as to reduce the phase noise in the carrier oscillation signal output by the voltage controlled oscillator;
an electrical signal coupler coupled between the electrical interferometer and the signal mixer to split a portion of the second electrical interferometer output signal representing the constructive interference as a second feedback signal; and
a second feedback loop coupled between the electrical signal coupler and the second input port of the voltage controlled oscillator to receive the second feedback signal to produce the injection oscillation signal that causes the voltage controlled oscillator to lock the carrier oscillation frequency at a frequency that maximizes an amplitude of the second electrical interferometer output signal representing the constructive interference to further reduce the phase noise in the carrier oscillation signal output by the voltage controlled oscillator.

In another embodiment, the disclosed technology can be implemented to provide a device that is separate from a voltage controlled oscillator and can be coupled to the voltage controlled oscillator to control an oscillation signal at a carrier oscillation frequency generated by the voltage controlled oscillator. This device includes:
a light source that produces light;
an optical modulator coupled to receive the oscillation signal at the carrier oscillation frequency generated by the voltage controlled oscillator to modulate light at the carrier oscillation frequency to produce modulated light;
an optical delay element coupled to receive a first portion of the modulated light from the optical modulator to output a first optical signal with a long delay caused by the optical delay element;
a first optical detector coupled to receive the first optical signal output by the optical delay element to produce a first electrical signal;
a second optical detector coupled to receive a second portion of the modulated light from the optical modulator, without the delay or with a short delay caused by the optical delay element, as a second optical signal to produce a second electrical signal;
an electrical interferometer coupled to receive the first and second electrical signals to cause an interference between the first and second electrical signals to produce a first electrical interferometer output signal representing a destructive interference that suppresses signaling at the carrier oscillation frequency and a second electrical interferometer output signal representing a constructive interference;
a signal mixer coupled to receive the first electrical interferometer output signal representing the destructive interference and the second electrical interferometer output signal representing the constructive interference to output a first feedback signal with an amplitude representing a phase noise of the carrier oscillation signal output by the voltage controlled oscillator with suppression of signaling at the carrier oscillation frequency;
a first electrical device output port coupled to receive the first feedback signal from the signal mixer to generate an output control voltage for controlling the voltage controlled oscillator;
an electrical signal coupler between the electrical interferometer and the signal mixer to split a portion of the second electrical interferometer output signal representing the constructive interference output as a second feedback signal;
a second electrical device output port coupled to receive the second feedback signal from the electrical signal coupler to produce an output injection oscillation signal for injecting locking the voltage controlled oscillator; and
an electrical device input port operable to be coupled to receive the oscillation signal generated by the voltage controlled oscillator and coupled to deliver the received oscillation signal generated by the voltage controlled oscillator to the optical modulator for modulating the light.

In yet another embodiment, the disclosed technology can be implemented to provide a device that is separate from an opto-electronic oscillator includes a loop having an optical loop section and an electrical loop section coupled to each other via a photodetector that converts light in the optical loop section into an electrical signal carried by the electrical loop section, and can be coupled to the an opto-electronic oscillator to control an oscillation signal at a carrier oscillation frequency generated by the opto-electronic oscillator. This device includes an optical input port to receive input light from the optical loop section of the opto-electronic oscillator; an optical splitter coupled to the optical input port to split the input light into a first input light signal and a second input light signal; an optical delay element coupled to receive the first input light signal to output a first optical signal with a long delay caused by the optical delay element; a first optical detector coupled to receive the first optical signal output by the optical delay element to produce a first electrical signal; a second optical detector coupled to receive the second input light signal, without the delay or with a short delay caused by the optical delay element to produce a second electrical signal; and an electrical interferometer coupled to receive the first and second electrical signals to cause an interference between the first and second electrical signals to produce a first electrical interferometer output signal representing a destructive interference that suppresses signaling at the carrier oscillation frequency and a second electrical interferometer output signal representing a constructive interference. This device further includes a signal mixer coupled to receive the first electrical interferometer output signal representing the destructive interference and the second electrical interferometer output signal representing the constructive interference to output a first feedback signal; a first electrical device output port coupled to receive the first feedback signal from the signal mixer to generate an output control voltage that is intended for being applied to modulation of light in the optical loop section of the loop of the opto-electronic oscillator; an electrical signal coupler between the electrical interferometer and the signal mixer to split a portion of the second electrical interferometer output signal representing the constructive interference as a second feedback signal; and a second electrical device output port coupled to receive the second feedback signal from the electrical signal coupler to produce an output injection oscillation signal that is intended for being injected into the electrical loop section of the loop of the opto-electronic oscillator.

In yet another embodiment, the disclosed technology can be implemented to provide a device that includes an opto-electronic oscillator (OEO) structured to include an OEO electrical output port that outputs an electrical oscillation signal at a carrier oscillation frequency, an OEO electrical injection input port to receive an electrical injection signal, an OEO electrical voltage input port to receive an electrical voltage signal, and an OEO optical output port to output an OEO optical signal. This device further includes an OEO control module coupled to the OEO and structured to include an optical input port coupled to receive the OEO optical signal from the OEO as input light, an optical splitter coupled to the optical input port to split the input light into a first input light signal and a second input light signal, an optical delay element coupled to receive the first input light signal to output a first optical signal with a delay caused by the optical delay element, a first optical detector coupled to receive the first optical signal output by the optical delay element to produce a first electrical signal, a second optical detector coupled to receive the second input light signal that does not pass through the optical delay element to produce a second electrical signal, an electrical interferometer coupled to receive the first and second electrical signals to cause an interference between the first and second electrical signals to produce a first electrical interferometer output signal representing a destructive interference that suppresses signaling at the carrier oscillation frequency and a second electrical interferometer output signal representing a constructive interference, a signal mixer coupled to receive the first electrical interferometer output signal representing the destructive interference and the second electrical interferometer output signal representing the constructive interference to output a first feedback signal, a first electrical device output port coupled to receive the first feedback signal from the signal mixer to generate an output control voltage that is coupled to the OEO electrical voltage input port as the electrical voltage signal to the OEO, an electrical signal coupler coupled between the electrical interferometer and the signal mixer to split a portion of the second electrical interferometer output signal representing the constructive interference as a second feedback signal, and a second electrical device output port coupled to receive the second feedback signal from the electrical signal coupler to produce an output injection oscillation signal that is coupled to the OEO electrical injection input port as the electrical injection signal to the OEO. The OEO in this device further includes an electric-optical modulator operable to generate a modulated optical signal as the OEO optical signal at the OEO optical output port based on an optical modulation in response to the electrical injection signal received at the OEO electrical injection input port and the electrical voltage signal received at the OEO electrical injection input port, a photodetector coupled to receive a portion of output light from the electric-optical modulator and operable to convert the received portion of output light from the electric-optical modulator to a photodetector electrical signal, and an electrical loop section coupled to receive the photodetector electrical signal, coupled to the OEO electrical voltage input port to receive the electrical voltage signal from the first electrical device output port, and coupled to the OEO electrical injection input port to receive the electrical injection signal from the second electrical device output port such that the electric-optical modulator, the photodetector, and the electrical loop section form an opto-electrical loop to sustain the electrical oscillation signal at the carrier oscillation frequency.

The above and other features of the disclosed technology are described in greater detail in the drawings and in the following description.

### BRIEF DESCRIPTION OF THE DRAWINGS

FIG. 1 includes FIGS. 1A, 1B, 1C, and 1D, and shows examples of FIG. 1A an externally modulated photonic delay-line (PhDL); FIG. 1B PhDL-enabled self-injection locking (SIL); FIG. 1C PhDL-enabled self-phase locked loop (SPLL); FIG. 1D combined PhDL-enabled SIL and SPLL for VCO phase noise reduction. MZM: Mach Zehnder modulator, SMF: single-mode fiber, PD: photodetector, CP: RF coupler, PS: phase shifter, LNA: low noise amplifier, LPF: low pass filter, DBM: double balanced mixer.

FIG. 2 shows an example of a combined dual-loop self-injection locking (DSIL) and CSI self-phase locking (CSI-SPL) scheme enabled by PhDL for VCO phase noise suppression. VA: variable attenuator, PD1 and PD2: photodetectors 1 and 2, MPS1 and MPS2: manual phase shifters 1 and 2, 3 dB CP: 3 dB RF coupler, LNA: low noise amplifier, RFC: RF coupler.

FIG. 3 includes FIGS. 3A and 3B, and shows an example of a Laplace domain phase noise model for PhDL enabled DSIL scheme FIG. 3A and the DSIL assisted CSI-SPL scheme FIG. 3B.

FIG. 4 includes FIGS. 4A, 4B, and 4C, and shows examples of FIG. 4A Schematic diagram of the self-built recirculating VCO; FIG. 4B Spectrum of a 10 GHz signal generated by the free running VCO. FIG. 4C measured phase noise of the 10 GHz signal in FIG. 4B.

FIG. 5 includes FIGS. 5A and 5B, and shows an example of the implementation of the combined DSIL and CSI-SPL scheme enabled by PhDL for VCO phase noise reduction. Inset: Photo of the experimental setup. PNA: phase noise/spectrum analyzer (Rohde & Schwarz FSWP-26), LD: DFB laser, MZM: Mach-Zehnder modulator; SMF1: long fiber coil of 2.15 km; SMF2: short fiber coil of 0.2 km; PD1 and PD2: photodetectors; MPS1 and MPS2: manual phase shifters for adjusting RF signal phases; 3 dB CP: 3 dB coupler, VA: variable attenuator for adjusting the power balance in MZI; LNA1, LNA2, LNA3: RF low noise amplifiers; CP1, CP2, CP3, CP4: signal monitoring couplers; DBM: double balanced mixer; LPF for setting up the gain and bandwidths for the CSI-SPL feedback loop (Stanford Research Systems Model SR560); VCO: the self-built low-quality voltage controlled oscillator.

FIG. 6 includes FIGS. 6A, 6B, 6C, and 6D, and shows examples of FIG. 6A Spectra of the self-built low-quality VCO with (red) and without (black) DSIL phase noise reduction. FIG. 6B Measured phase noise curves of the self-built low-quality VCO with (red) and without (dotted black) DSIL, as compared with that of the calculation (dashed blue). FIG. 6C Phase noise curves of the self-built low-quality VCO with DSIL of different injection powers; FIG. 6D PNSR of the self-built low-quality VCO with DSIL of different injection powers at a frequency offset of 10 kHz, extracted from FIG. 6C, as compared with the calculated PNSRs with (dashed green) and without (blue). In FIG. 6A and FIG. 6B, the injection power of 15.5 dBm.

FIG. 7 shows an example for the spectra comparison of the signal around 10 GHz generated by the VCO without noise reduction (blue), with only the DSIL noise reduction (green), and with the joint DSIL and CSI-SPL noise reduction (red). The center frequencies of the three signals are slightly different, with the free-running VCO centered at 9.994 GHZ, and the VCO with joint DSIL and CSI-SPL slightly up by 6 kHz due to the frequency pulling of the feedback loops. They are centered together for comparison.

FIG. 8 includes FIGS. 8A, 8B, 8C, 8D, 8E, and 8F, and shows examples of measured phase noise curves (blue) of the VCO deploying the joint DSIL and CSI-SPL noise reduction scheme with the LPF gain of 26 dB and LPF bandwidths of 1 MHz FIG. 8A, 100 KHz FIG. 8B, 10 KHz FIG. 8C, 1 kHz FIG. 8D, and 100 Hz FIG. 8E, as compared with their corresponding simulation curves (red), with the inset in each figure showing the corresponding measured open-loop gain Gₒₚₑₙ of the CSI-SPL loop; FIG. 8F Comparison of measured (red circles) and calculated (blue squares) phase noise suppression ratios (PNSR) of joint DSIL and CSI-SPL at 10 KHz frequency offset for different LPF 3 dB bandwidths, extracted from the data in FIG. 8A to FIG. 8E. The fiber lengths in the experiments are chosen to be 2150 m and 200 m, respectively. The parameters used in Eq. (5), including G₁, G_{CSI}, S_{φ}_{_{vco}} (fₘ), and S_{φ}_{_{PhDL}} (fₘ), are all obtained experimentally, while the noise S_{φ}_{ₙ} in the electronic circuit of LPF is ignored.

FIG. 9 includes FIGS. 9A, 9B, 9C, 9D, 9E, and 9F, and shows examples of measured phase noise curves (blue) of the VCO deploying the joint DSIL and CSI-SPL noise reduction scheme with the LPF bandwidth of 1 MHz and LPF gains of 26 dB FIG. 9A, 20 dB FIG. 9B, 14 dB FIG. 9C, 6 dB FIG. 9D, and 0 dB FIG. 9E, as compared with their corresponding simulation curves (red), with the inset in each figure showing the corresponding open-loop gain Gₒₚₑₙ of the CSI-SPL loop; FIG. 9F Comparison of measured and calculated PNSR of joint DSIL and CSI-SPL at 10 kHz for different LPF gains extracted from the data in (a) to (e). The fiber lengths in the experiments are chosen to be 2150 m and 200 m, respectively. The parameters used in Eq. (5), including G_{I}, G_{CSI}, S_{φ}_{_{vco}}(fₘ), and S_{φ}_{_{PnDL}}(fₘ), are all obtained experimentally, while the noise S_{φ}_{ₙ} in the electronic circuit of LPF is ignored.

FIG. 10 includes FIGS. 10A, 10B, and 10C, and shows examples of FIG. 10A The spectra of a 8.806 GHz VCO with (red) and without (blue) deploying the DSIL assisted CSI-SPL noise reduction scheme; FIG. 10B The phase noise curves of the 8.806 GHz VCO with (red) and without (black) deploying the DSIL assisted CSI-SPL scheme; FIG. 10C The phase noise curves of the 8.817 GHz (blue) and 10 GHz (red) VCOs with the DSIL assisted CSI-SPL scheme, as compared with those generated by a high-performance commercial microwave signal source (Keysight N5183B).

FIG. 11A shows an example of an embodiment of an active PhDL enabled CSI-DSIL module including a laser, a modulator, an RF input port for modulating the MZM, a CSI port for the CSI-SPL loop, and a DSIL port for the DSIL loop for VCO phase noise reduction.

FIG. 11B shows an example of applying the PhDL CSI-DSIL module to a VCO for phase noise reduction. LD: Laser diode, MZM: Mach-Zehnder modulator; PD: photodetector, MPS: manual phase shifter, VA: variable attenuator, LNA: low noise amplifier, DBM: double balanced mixer, LPF: low pass filter.

FIGS. 12A and 12B, 13 and 14 show examples of various designs of optoelectronic oscillator (OEO) or coupled optoelectronic oscillator (COEO) devices as voltage controlled oscillators for implementing the disclosed PhDL enabled CSI-DSIL technique.

FIG. 15 includes FIGS. 15A, 15B, 15C, 15D and 15E. FIG. 15A shows an example of a passive PhDL enabled CSI-DSIL module for being coupled to an optoelectronic oscillator (OEO) or coupled optoelectronic oscillator (COEO) to reduce the OEO phase noise. In operation, the CSI port and the DSIL port are connected to the VC port and the injection port of the OEO/COEO. The optical output port of the OEO/COEO is connected to the optical input port of the PhDL module. FIG. 15B shows an example of a photonic integrated OEO having a DFB laser, an MZM, a delay line, a PD, and an RF circuit. FIG. 15C shows an example of a first embodiment of a photonic integrated COEO having a reflective semiconductor optical amplifier (RSOA) as a gain medium, a MZM, a delay line, a PD, and a RF circuit. FIG. 15D shows an example of a second embodiment of a photonic integrated COEO having a RSOA, an active micro-ring resonator (MRR), a distributed Bragg reflector (DBR), a PD, and an RF circuit. The active MRR can be modulated to shift its resonant peak and hence the power of the transmitted light. FIG. 15E shows an example of a third embodiment of a COEO consisting of a RSOA, an MZM, a passive MRR, and DBR, a PD, and a RF circuit. The illustrated RF circuits include a low noise amplifier (LNA), a bandpass filter (BPF), an RF coupler, and a voltage-controlled phase shifter (VPS). The Injection port and the VC port of the OEO and COEO are marked in red.

### DETAILED DESCRIPTION

Certain existing methods for suppressing the phase noise in RF sources may be primarily categorized into two types: The first type involves using techniques, such as external injection locking (EIL)^{4,5}, phase-locked loops (PLL)^{6,7}, or a combination of EIL and PLL (EIL-PLL)⁸⁻¹¹ to lock an oscillation signal to a high-performance external reference source. These techniques require the phase noise of the external reference to be significantly lower than that of the RF sources, thereby increasing the cost and complexity of the noise reduction systems. The second type deploys self-injection locking (SIL)¹²⁻¹⁷ self-phase-locked loops (SPLL)¹⁸⁻²², or combined self-injection and self-phase locking (SIL-SPLL)^{23,24} to suppress phase noise in the RF sources. Compared to the first type, these techniques in the second type avoid the need for external reference signals, reducing the complexity and cost of the noise reduction systems.

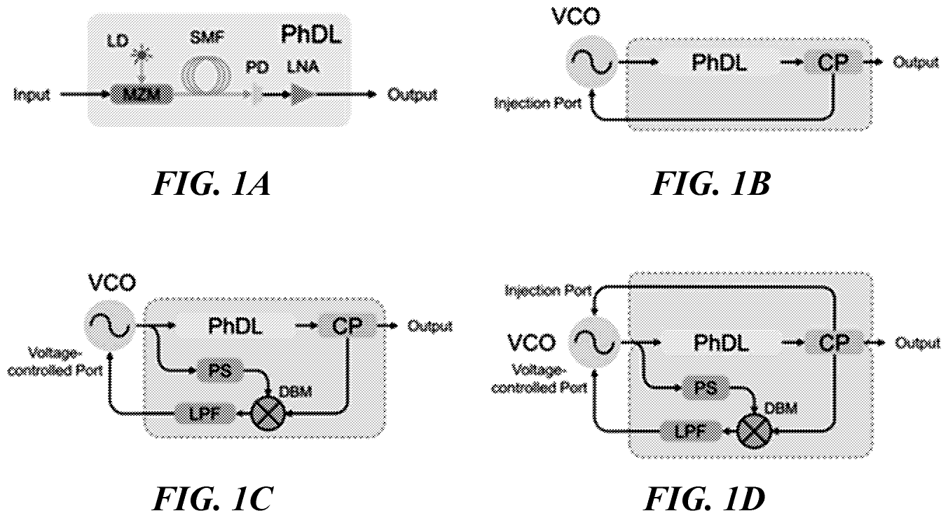

In 2003, H. Chang conducted theoretical analysis and experimental validation of a SIL system enabled by coaxial cable delay lines¹², establishing an inverse relationship between the phase noise of the oscillator and the length of the delay line. However, due to the high losses in coaxial cables, achieving low phase noise with long delay lines was not feasible in practice for various coaxial cable based devices¹³. In contrast, photonic delay lines (PhDL) using optical fibers for signal transmission have been shown to provide better performance for SIL¹⁵ due to the advantages of low loss, low cost, and compact size of the photonic delay devices. FIG. 1A shows an example of a PhDL device which includes a laser diode (LD), a Mach-Zehnder modulator (MZM), a single-mode fiber (SMF), a photodetector (PD), and low noise amplifier (LNA). In other implementations, a PhDL device may also be implemented by directly modulating the LD without using the MZM. The PhDL can be used in a SIL system to provide the required long delay for reducing the phase noise of a voltage-controlled oscillator (VCO), as illustrated in FIG. 1B. In operation, the RF signal generated by the VCO first modulates the light from the LD via the MZM to produce a modulated optical signal, which then transmits through the optical fiber, being converted back into RF signal by the PD, and finally amplified by the LNA before reinjecting into the VCO. This process increases the effective Q-factor of the oscillator, reducing frequency fluctuations and achieving phase noise suppression proportional to the delay length¹⁴. However, the amount of phase noise suppression in the PhDL-enabled SIL systems is ultimately limited by the phase noise in the PhDL, originated from the residual phase noise (RPN) of the LNA and the relative intensity noises (RIN) from the laser and the Reighleigh scattering in the fiber^{15,17,25}, in addition to the oscillator's injection power and locking bandwidth.

Another way for reducing the VCO phase noise is using the PhDL-enabled self-phase locking (SPL) loop, as illustrated in FIG. 1C. Unlike the system using PhDL-enabled SIL, a system deploying SPL first measures the phase noise of the VCO by mixing the signal directly coming from the VCO with its delayed replica. The measured phase difference represents the phase noise of the VCO, which is then filtered and amplified by the low-pass filter (LPF) before feedbacking to the VCO to minimize the phase noise^{18,20-22}. By deploying 3 km and 5 km dual photonic delay lines in a PhDL-enabled SPL system, a phase noise suppression of 65 dB at 1 KHz frequency offset from a 10 GHz carrier was achieved¹⁹. However, the final phase noise can be achieved with this technique is limited by noises in the feedback loop, including the RPN of the LNA and the RIN from the laser and fiber in the PhDL, yielding a phase noise of only −91 dBc/Hz and −100 dBc/Hz at 1 kHz and 10 kHz offset from the 8.5 GHz carrier, respectively.

Injection locking with an external RF source (EIL) combined with a phase-locked loop (PLL) can also be used to suppress VCO's phase noise⁸. Experiments and simulations demonstrated that such an EIL-PLL exhibits lower close-to-carrier phase noise and a broader injection locking range than either EIL or PLL alone. Similar experiments^{9,11} and theoretical analyses¹⁰ further confirm that EIL-PLL can suppress oscillator phase noise and extend the locking range.

To remove the requirement of an external reference RF source in an EIL-PLL system, it is feasible to combine the self-injection locking with self-phase-locked loop (SIL-SPLL) to suppress VCO phase noise. FIG. 1D illustrates the structure of a PhDL-enabled SIL-SPLL system, where part of the VCO signal delayed by the PhDL directly feeds back into the VCO as the SIL signal, while another part forms the SPLL with the un-delayed signal directly from the VCO. L. Zhang et al.^{23,24} proposed SIL-SPLL for reducing phase noise in a 10 GHz dielectric resonator oscillator (DRO), achieving phase noise levels of −100 dBc/Hz at 1 KHz and −125 dBc/Hz at 10 kHz using a dual-fiber PhDL of 5 km and 8 km, corresponding to phase noise suppression ratios of 16 dB and 13 dB at 1 kHz and 10 kHz offsets, respectively. Unfortunately, SIL-SPLL also inherits the limitations imposed by the noises in the PhDL, namely the RPN of the LNA and the RIN originated from the light source and the fiber.

Carrier suppression interferometry (CSI) was initially deployed to measure the close-to-carrier phase noise of two-port microwave devices^{26,27}. In CSI systems, carrier suppression allows for significant amplification of the phase noise under test without causing saturation, thereby enhancing phase noise measurement sensitivity. Additionally, CSI converts the phase noise under the test into amplitude noise, effectively eliminating the RPN of the LNAs from limiting measurement sensitivity. Yao et al.²⁸⁻³⁰ first proposed and implemented a PhDL-enabled CSI self-phase locking (CSI-SPL) scheme in 2000 to suppress the phase noise of an optoelectronic oscillator (OEO), demonstrated a 20 dB phase noise suppression at 10 Hz offset from a 10 GHz carrier. The theory of using a PhDL-enabled CSI system to measure the ultra-low phase noise was established and experimentally validated in 2021²⁵, which shows that the PhDL-enabled CSI can effectively prevent the phase noise contributions of the LNAs and the RINs in the PhDL from limiting the measurement sensitivity of the system, which assures us that the PhDL-enabled CSI-SPL scheme can be applied to any VCO to effectively suppress its phase noise to a level much below the limitation imposed by the PhDL.

The technology disclosed in this patent document can be implemented to reduce the phase noise in a low quality, inexpensive VCO or converts a low quality, inexpensive VCO with high phase noise into a high-performance RF/microwave source with extremely low phase noise and low spurs by deploying the dual-loop self-injection locking (DSIL) assisted CSI-SPL scheme enabled by PhDL to significantly reduce the phase noise of the original VCO over a wide offset frequency range. In this example of a joint DSIL and CSI-SPL phase noise reduction system, the DSIL functions to suppress the phase noise of the VCO in a broad frequency range while at the same time establishes a favorable operation condition for the CSI-SPL to further reduce the phase noises in the feedback loop, particularly the RPN and RIN in the PhDL, which cannot be suppressed by the SIL and SIL-SPLL schemes discussed previously²⁵.

In addition, a Laplace phase noise analysis model can be used to better understand the operation of the joint DSIL and CSI-SPL scheme, which can be used to optimize the related loop parameters for designing such devices. With the guidance of the analysis results, a self-built low quality VCO at 10 GHz with phase noises of −77 dBc/Hz and −105 dBc/Hz at frequency offsets of 1 kHz and 10 kHz, respectively, was transformed into a high-performance RF source with phase noise levels of −123 dBc/Hz and −144 dBc/Hz at the corresponding frequency offsets from the VCO's 10 GHz center frequency, respectively, corresponding to remarkable phase noise reductions of 46 dB and 39 dB respectively of the free-running VCO.

In the constructed device, the spurs of our phase noise reduced VCO is below-110 dB, about 30 dB better than an OEO with comparable phase noise performance³¹, because the long PhDL is not involved in any oscillation. The experimental results agreed well with our analysis results. Similar performance was also observed when the VCO was made to operate at 8.817 GHz with 20 dB higher free-running phase noise, achieving even more impressive noise reductions of 65 dB and 60 dB at 1 kHz and 10 kHz, respectively.

TABLE•1
•Comparison•of•Different•Methods•for•Suppressing•Oscillator•Phase•Noise¶

| | | | Fiber¶ | | | | | |
|---|---|---|---|---|---|---|---|---|
| | | | Loop• | | | | | |
| | | f₀¶ | length• | | | | | |
| Ref.¤ | Method¤ | (GHz)¤ | (km)¤ | Phase•noise•(dBc/Hz)¤ | | Reduction•ratio•(dB)¤ | | ¤ |
| —¤ | —¤ | —¤ | —¤ | 1 kHz¤ | 10 kHz¤ | 1 kHz¤ | 10 kHz¤ | ¤ |
| 16¤ | SIL¤ | 10.8¤ | 2.4¤ | ¤ | −100¤ | ¤ | 55¤ | ¤ |
| 18¤ | SPLL¤ | 8.5¤ | 3•&•5¤ | −91¤ | −100¤ | 65¤ | 32¤ | ¤ |
| 20¤ | | 10.7¤ | 2¤ | −88¤ | −100¤ | 30¤ | 14¤ | ¤ |
| 22¤ | SILPLL¤ | 10¤ | 5•&•8¤ | −100¤ | −125¤ | 16¤ | 13¤ | ¤ |
| This•work¤ | DSIL• | 10•¶ | 2.15¶ | −123¶ | −144¶ | 46¶ | 39¶ | ¤ |
| | assisted• | | | | | | | |
| | CSI-SPL¤ | 8.817¤ | &•0.2¤ | −121¤ | −142¤ | 65¤ | 60¤ | |

Table 1 is the comparison of the performance metrics for various noise reduction schemes from different research groups, which shows significant improvement of our DSIL assisted CSI-SPL scheme over the previous schemes. In essence, our DSIL assisted CSI-SPL scheme overcomes the phase noise limitations imposed by the RPN of the LNA and the RIN in the PhDL, removing perhaps the last hurdle in oscillator's noise reduction, which can be used to turn low-cost oscillators into high performance (low phase noise and low spurs) signal sources, particularly attractive at frequencies up to 220 GHz and beyond (limited only by the modulator's speed in the PhDL, with up to 220 GHz demonstrated³²) where low phase noise signal sources are difficult and expensive to make. Finally, but most importantly, we anticipate that the scheme can be applied to an OEO made with a photonic integrated circuit (PIC)³³⁻³⁶ to convert the on-chip OEO with relatively high phase noise into a high-performance oscillator with ultra-low phase noise and ultra-low spurs.

Analysis of Phase Noise Reduction of a VCO with DSIL Assisted CSI-SPL

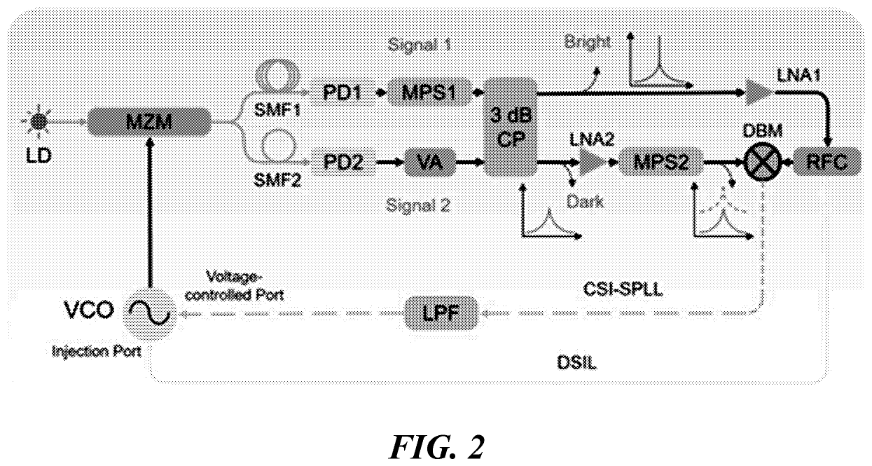

FIG. 2 shows an example of a system configuration for suppressing the phase noise of a VCO by combining (1) PhDL-enabled the dual-loop self-injection locking (DSIL) and (2) photonic delay-line (PhDL) enabled carrier suppression interferometry (CSI) and self-phase locking (SPL) (CSI-SPL). Continuous light from the LD enters a dual-output MZM to be modulated by the RF signal from the VCO, which then passes through two different lengths of optical fiber loops, SMF1 and SMF2, before converting back to RF signals by photodiodes PD1 and PD2, which are labeled Signal 1 and Signal 2. As can be seen from FIG. 2, the two optical fibers, together with the two PDs, the manual phase shifter (MPS1), and the variable attenuator (VA) form a hybrid optical-RF Mach-Zehnder interferometer (MZI). Signal 1 passes through the MPS1, and signal 2 passes through the VA before interfering in the 3-dB coupler (CP). Adjustments of MPS1 and VA ensure that the outputs from the 3-dB CP exhibit constructive interference (“bright” port) and destructive interference (“dark” port) with the highest extinction ratio (defined as the ratio of the RF power from the “bright” port over that from the “dark” port).

The signal from the “bright” port is amplified by LNA1 and split into two parts by an RF coupler (RFC), with one part directly injected into the VCO via a coaxial cable to form a DSIL loop, which suppresses VCO phase noise over a wide frequency offset range. At the same time, the injection locking tends to force the MZI to operate with the maximal extinction ratio, because the frequency corresponding to the maximum “bright” port output of the MZI has the strongest power for the injection locking of the VCO, which in turn automatically maintains the optimal condition (the highest carrier suppression ratio) for the CSI-SPL loop to function²⁵.

The signal from the “dark” port is the carrier suppressed signal, primarily derived from VCO phase noise, which is amplified by a high-gain LNA (LNA2) before feeding into the RF port of a double-balanced mixer (DBM) to mix with the signal from the “bright” port (entering from the LO port of the DBM) via RFC with a nominal phase difference of either 0° or 180° for amplitude noise detection because the phase noise of the VCO has already been converted to amplitude noise by the MZI. This way, the phase noise contributions from the LNAs and the RIN in the PhDLs can be circumvented²⁵. The output from the DBM is a low-frequency voltage signal representing the VCO phase noise²⁵, which is then low-pass filtered and fed back to the VCO to further suppress its phase noise. As described in²⁵, it is the phase noise of the signal in the “dark” port that can be extracted, which can be amplified significantly without saturation to boost the measurement sensitivity.

Phase Noise Analysis of the VCO with DSIL Alone

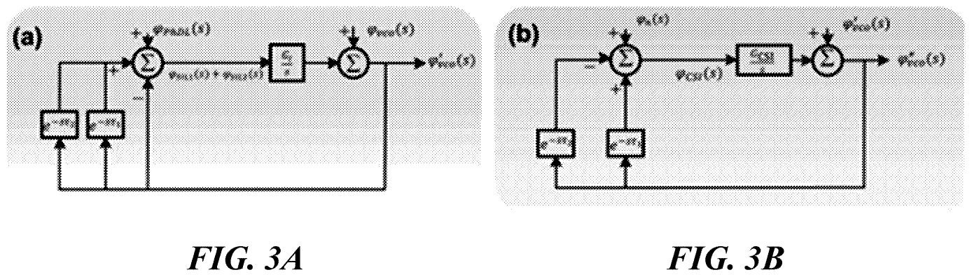

In the PhDL-enabled DSIL loop, the signal injected into the VCO is the delayed replica of the VCO signal itself¹⁷. Because there are two different delays in the DSIL loop, the Laplace domain phase noise model for the DSIL loop can be established as shown in FIG. 3A.

When the DSIL system is at steady state, the phase noise can be expressed as¹⁷:

$${φ}_{SIL 1} ( s ) = {e}^{- s {τ}_{1}} {φ}_{v c o}^{′} ( s ) - {φ}_{v c o}^{′} ( s ) \qquad ( 1 a )$$

$${φ}_{SIL 2} ( s ) = {e}^{- s {τ}_{2}} {φ}_{v c o}^{′} ( s ) - {φ}_{v c o}^{′} ( s ) \qquad ( 1 b )$$

$${φ}_{v c o}^{′} ( s ) = {φ}_{v c o} ( s ) + \frac{{K}_{I} [ {φ}_{SIL 1} ( s ) + {φ}_{SIL 2} ( s ) + {φ}_{P h D L} ( s ) ]}{s} \qquad ( 1 c )$$

where

$${φ}_{v c o}^{′} ( s )$$

and φ_{vco}(s) are the phase noises of the injection locked VCO and the free-running VCO, respectively, φ_{SIL1}(s) and φ_{SIL2}(s) are the instantaneous beat signal phases of the oscillating signal after delays τ₁ and τ₂, respectively, and φ_{PhDL}(s) is the phase noise of the PhDL-enabled DSIL loop primarily contributed from the RPN and RIN in the PhDL. In addition, K_{I}=ρ·Δf is the injection locking coefficient of the self-injection loop, ρ=Pᵢₙⱼ/P_{osc} is the ratio of the injection signal power Pᵢₙⱼ over the oscillating signal power P_{osc}, and Δf=ω₀/2Q is the injection bandwidth of the oscillator, determined by the oscillation frequency ω₀ and the quality factor Q of the VCO.

Substituting (1a) and (1b) into (1c), one obtains the Laplace domain phase noise for the DSIL:

$${φ}_{v c o}^{′} ( s ) = \frac{s \cdot {φ}_{v c o} ( s )}{s + {K}_{I} ( 2 - {e}^{- s {τ}_{1}} - {e}^{- s {τ}_{2}} )} + \frac{{φ}_{P h D L} ( s )}{s / {K}_{I} + ( 2 - {e}^{- s {τ}_{1}} - {e}^{- s {τ}_{2}} )} \qquad ( 2 a )$$

$${K}_{I} = ( {P}_{i n j} / {P}_{o s c} ) \cdot {ω}_{0} / ( 2 Q ) \qquad ( 2 b )$$

Eq. (2a) indicates that the phase noise

$${φ}_{v c o}^{′} ( s )$$

of the injection locked VCO is determined by the injection locking coefficient K_{I} of the DSIL, the time delays τ1 and τ₂ of the dual loops, and the noise φ_{PhDL} of the PhDL. At steady state, the phase noise

$${φ}_{v c o}^{′} ( s )$$

of the injection locked VCO is suppressed by the amount inversely proportional to K_{I}, however, limited by the phase noise φ_{PhDL}(s) in the PhDL, as indicated by the second term in Eq. (2a).

The power spectral density

$${S}_{{φ}_{v c o}^{′}}$$

of phrase noise

$${φ}_{v c o}^{′} ( s )$$

can be obtained from Eq. (2) as:

$${S}_{{φ}_{v c o}^{′}} ( {f}_{m} ) = {\vert \frac{j 2 π {f}_{m}}{j 2 π {f}_{m} + {K}_{I} ( 2 - {e}^{- j 2 π {f}_{m} {τ}_{1}} - {e}^{- j 2 π {f}_{m} {τ}_{2}} )} \vert}^{2} {S}_{{φ}_{v c o}} ( {f}_{m} ) + {\vert \frac{1}{j 2 π {f}_{m} / {K}_{I} + ( 2 - {e}^{- j 2 π {f}_{m} {τ}_{1}} - {e}^{- j 2 π {f}_{m} {τ}_{2}} )} \vert}^{2} {S}_{{φ}_{P h D L}} ( {f}_{m} ) = \frac{{π}^{2} {f}_{m}^{2}}{\begin{matrix}{π}^{2} {f}_{m}^{2} - 2 π {f}_{m} {K}_{I} sin ( 2 π {f}_{m} \overline{τ} ) cos ( π {f}_{m} Δτ ) + \\ {K}_{I}^{2} [ 1 - cos ( 2 π {f}_{m} \overline{τ} ) cos ( π {f}_{m} Δτ ) + {cos}^{2} ( π {f}_{m} Δτ )\end{matrix}} {S}_{{φ}_{v c o}} ( {f}_{m} ) + \frac{{K}_{I}^{2}}{\begin{matrix}4 {π}^{2} {f}_{m}^{2} - 8 π {f}_{m} {K}_{I} sin ( 2 π {f}_{m} \overline{τ} ) cos ( π {f}_{m} Δτ ) + \\ 4 {K}_{I}^{2} [ 1 - cos ( 2 π {f}_{m} \overline{τ} ) cos ( π {f}_{m} Δτ ) + {cos}^{2} ( π {f}_{m} Δτ )\end{matrix}} {S}_{{φ}_{P h D L}} ( {f}_{m} ) \qquad ( 3 )$$

where S_{φ}_{_{vco}}(fₘ) and S_{φPhDL}(fₘ) are the phase noise power spectral densities of the free running VCO and the PhDL, respectively, and

$$\overline{τ} = \frac{{τ}_{1} + {τ}_{2}}{2}$$

and Δτ=τ₁−τ₂ represent the average and the difference of the two time delays in the interferometer, respectively. In Eq. (3), s=j2πfₘ is used.

It is clear from Eq. (3) that the delays τ₁ and τ₂, the injection coefficient K_{I}, and the phase noise in the PhDL collectively determine the amount of phase noise suppression in the DSIL loop. For the case of infinite K_{I}, the phase noise of the VCO reaches that of the PhDL.

Phase Noise Analysis of the VCO with Combined DSIL and CSI-SPL Loops

The above analysis of the device in FIG. 3A only involves DSIL where the CSI-SPL loop in FIG. 2 is open. When both the DSIL loop and the CSI-SPL loop are closed, the device in FIG. 2 is a DSIL assisted CSI-SPL loop, in which the phase noise of the VCO is first suppressed over a wide offset frequency range by the DSIL before being further suppressed by the CSI-SPL loop to lift the phase noise limitation imposed by the phase noise in the PhDL.

FIG. 3B shows the Laplace domain phase noise model of the CSI-SPL loop, in which phase noise

$${φ}_{v c o}^{′} ( s )$$

of the DSIL of Eq. (2) is taken as the DBM output in FIG. 2 to be fed back to the VCO as the error signal of the CSI-SPL loop to further suppress the phase noise of the VCO. In other words, the phase noise of the DSIL loop is used as the input to the CSI-SPL loop. Assuming the variable attenuator VA and the manual phase shifters MPS1 and MPS2 in FIG. 2 are optimally tuned for achieving a perfect carrier suppression²⁵, the following relationship can be obtained:

$${φ}_{CSI} ( s ) = ( {e}^{- s {τ}_{1}} - {e}^{- s {τ}_{2}} ) {φ}_{v c o}^{″} ( s ) + {φ}_{n} ( s ) \qquad ( 4 a )$$

$${φ}_{v c o}^{″} ( s ) = {φ}_{v c o}^{′} ( s ) + {G}_{CSI} {φ}_{CSI} ( s ) \qquad ( 4 b )$$

where φ_{CSI}(s) is the error signal generated by the CSI-SPL loop, φₙ(s) is the electronic noise in the CSI-SPL loop from the DBM, the LPF and the LNA1 and LNA2 (LNA amplitude noise) in FIG. 2,

$${φ}_{v c o}^{″} ( s )$$

in the phase noise of VCO with the joint DSIL and CSI-SPL phase noise reduction scheme, G_{CSI}=K_{CS}·F(s)·K_{vco}/s is the gain factor of the CSI-SPL loop, in which K_{vco}/s is the VCO tuning sensitivity, K_{CS} is the gain of CSI phase discriminator, and F(s) is the transfer function of the LPF. Substituting (2a) and (4a) into (4b), one obtains the phase noise of the VCO deploying the joint DSIL and CSI-SPL noise reduction scheme.

$${φ}_{v c o}^{″} ( s ) = \frac{s}{s + {K}_{I} ( 2 - {e}^{- s {τ}_{1}} - {e}^{- s {τ}_{2}} )} \frac{{φ}_{v c o} ( s )}{1 - {G}_{CSI} ( {e}^{- s {τ}_{1}} - {e}^{- s {τ}_{2}} )} + \frac{1}{s / {K}_{I} + ( 2 - {e}^{- s {τ}_{1}} - {e}^{- s {τ}_{2}} )} \frac{{φ}_{P h D L} ( s )}{1 - {G}_{CSI} ( {e}^{- s {τ}_{1}} - {e}^{- s {τ}_{2}} )} + \frac{{φ}_{n} ( s )}{1 / {G}_{CSI} - ( {e}^{- s {τ}_{1}} - {e}^{- s {τ}_{2}} )} \qquad ( 5 )$$

Eq. (5) indicates that the phase noise of the combined DSIL and CSI-SPL scheme includes the transfer functions associated with phase noise φ_{vco}(s) of the free-running VCO, the phase noise φ_{PhDL}(s) of the PhDL, and the electronic noise φₙ(s) in the CSI-SPL loop. Compared to the DSIL phase noise reduction result of Eq. (2), one can see that the transfer function associated with φ_{vco}(s) in the combined DSIL and CSI-PLL noise reduction scheme is the product of the transfer functions of the DSIL and CSI-SPL, resulting in further phase noise suppression proportional to G_{CSI} due to the action of the CSI-SPL. When G_{CSI} approaches zero, the phase noise of the combined DSIL and CSI-SPL will revert to the phase noise of the DSIL alone, as expected. However, the ultimate phase noise

$${φ}_{v c o}^{″} ( s )$$

of the VCO with combined DSIL and CSI-PLL noise reduction scheme as G_{CSI} approaches to infinity is limited by the electronic noise φₙ(s) of the CSI-PLL circuit, which are expected to be much lower than the phase noises in the PhDL.

Finally, the phase noise power spectral density of the VCO with the DSIL assisted CSI-SPL phase noise reduction scheme of FIG. 2 can be obtained from Eq. (5) as:

$${S}_{{φ}_{v c o}^{″}} ( {f}_{m} ) = \frac{{π}^{2} {f}_{m}^{2}}{\begin{matrix}{π}^{2} {f}_{m}^{2} - 2 π {f}_{m} {K}_{I} sin ( 2 π {f}_{m} \overline{τ} ) cos ( {πf}_{m} Δ τ ) + \\ {K}_{I}^{2} [ 1 - cos ( 2 π {f}_{m} \overline{τ} ) cos ( π {f}_{m} Δ τ ) + {cos}^{2} ( π {f}_{m} Δ τ ) ]\end{matrix}} \times \frac{1}{\begin{matrix}1 + 4 [ Re ( {G}_{CSI} ) sin ( 2 π {f}_{m} \overline{τ} ) - Im ( {G}_{CSI} ) cos ( 2 π {f}_{m} \overline{τ} ) + \\ {\vert {G}_{CSI} \vert}^{2} sin ( π {f}_{m} Δτ ) ] sin ( π {f}_{m} Δ τ )\end{matrix}} {S}_{{φ}_{v c o}} ( {f}_{m} ) + \frac{{K}_{I}^{2}}{\begin{matrix}4 {π}^{2} {f}_{m}^{2} - 8 π {f}_{m} {K}_{I} sin ( 2 π {f}_{m} \overline{τ} ) cos ( π {f}_{m} Δ τ ) + \\ 4 {K}_{I}^{2} [ 1 - cos ( 2 π {f}_{m} \overline{τ} ) cos ( π {f}_{m} Δ τ ) + {cos}^{2} ( π {f}_{m} Δ τ ) ]\end{matrix}} \times \frac{1}{\begin{matrix}1 + 4 [ Re ( {G}_{CSI} ) sin ( 2 π {f}_{m} \overline{τ} ) - Im ( {G}_{CSI} ) cos ( 2 π {f}_{m} \overline{τ} ) + \\ {\vert {G}_{CSI} \vert}^{2} sin ( π {f}_{m} Δτ ) ] sin ( π {f}_{m} Δ τ )\end{matrix}} {S}_{{φ}_{P h D L}} ( {f}_{m} ) + \frac{\vert {G}_{CSI} {\vert}^{2}}{\begin{matrix}1 + 4 [ Re ( {G}_{CSI} ) sin ( 2 π {f}_{m} \overline{τ} ) - Im ( {G}_{CSI} ) cos ( 2 π {f}_{m} \overline{τ} ) + \\ {\vert {G}_{CSI} \vert}^{2} sin ( π {f}_{m} Δτ ) ] sin ( π {f}_{m} Δ τ )\end{matrix}} {S}_{{φ}_{n}} ( {f}_{m} ) \qquad ( 6 )$$

The addition of CSI-SPL loop can 1) further reduce the phase noise S_{φ}_{_{vco}}(fₘ) of the free-running VCO, and 2) suppress the phase noise contributions from the PhDL, primarily the residual phase noise of the LNA and the RIN noise in the PhDL, however, with a phase noise floor determined by the electronic noise in the CSI-SPL circuit, which is expected to be much lower than the phase noise of the PhDL. The amount of phase noise reduction is determined by the injection locking coefficient K_{I} and the gain factor G_{CSI} of the DSIL and the CSI-SPL loops, respectively, as well as the fiber delays τ₁ and τ₂.

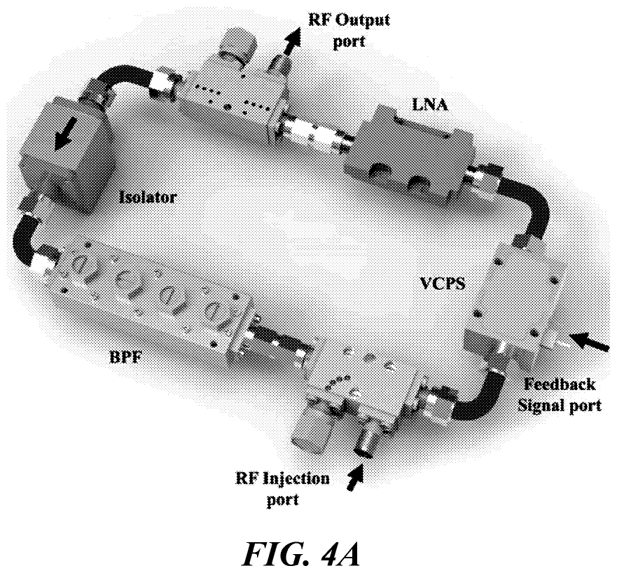

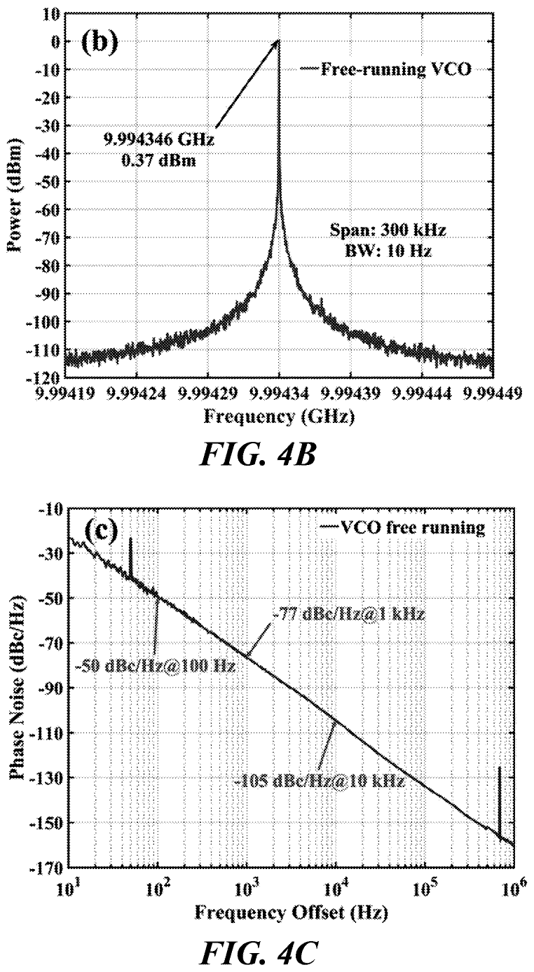

A low-quality X-band VCO based on a ring oscillator circuit design was constructed as shown in FIG. 4A to demonstrate the effectiveness of the above DSIL assisted CSI-SPL phase noise reduction scheme. This particular X-band VCO includes a 10 GHz bandpass filter (BPF) with 12 MHz bandwidth for mode selection, an X-band LNA with a gain of 15 dB for compensating for the loop losses and sustaining oscillation, a voltage-controlled phase shifter (VCPS) for frequency-tuning, an isolator to ensure unidirectional oscillation, and two 6-dB RF couplers: one for outputting generated RF signal and the other for injection locking. The Q-factor of the VCO in FIG. 4A is characterized to be approximately 820, with an injection bandwidth of 6.097 MHz. The spectrum of a generated RF signal at 9.994 GHz is shown in FIG. 4B, with measured phase noises of −77 dBc/Hz at 1 KHz and −105 dBc/Hz at 10 kHz from the carrier, as shown in FIG. 4C.

By replacing the 10 GHz BPF of 12 MHz bandwidth with an 8.8 GHz BPF of 102 MHz bandwidth, a VCO operating around 8.8 GHz with much higher phase noises of −56 dBc/Hz at 1 kHz and −82 dBc/Hz at 10 kHz from the carrier can be obtained, which will be also used for the phase noise reduction demonstration in subsection 3.4 below.

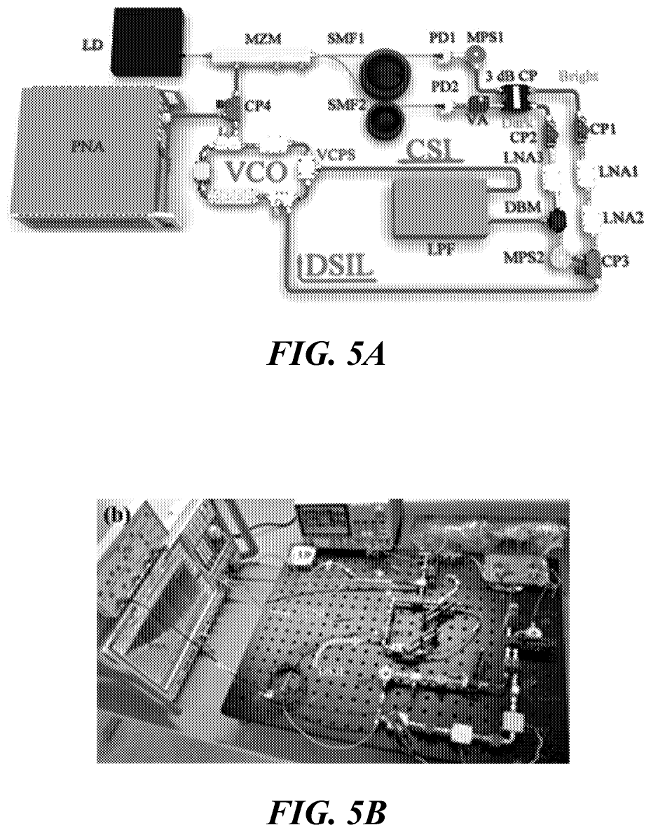

FIG. 5B shows the implementation of the combined DSIL and CSI-SPL phase noise reduction scheme of FIG. 2 for drastically improving the performance of the low quality VCO device of FIG. 4A. In the experiment, LD is a 1550 nm DFB laser with an output power of 90 mW and the MZM has a half-wave voltage of 5 V and the fiber lengths of SMF1 and SMF2 are chosen to be 2.15 km and 0.2 km (corresponding to mode spacings of 96 kHz and 1 MHz, respectively), while the two high speed photodetectors, PD1 and PD2, have a responsivity of 0.84 V/W for converting modulated optical signal into a RF signal.

The outputs from PD1 and PD2 are fed into MPS1 and VA, respectively, and then injected into the two input ports of the 3-dB coupler to form an MZI in which the two signals interfere before outputting from the two output ports of the 3-dB coupler. By fine-tuning MPS1 and VA, the signal at one output port of the 3 dB coupler undergoes constructive interference (“bright” port), while the signal at the other output port undergoes destructive interference (“dark” port). The carrier suppression ratio can be monitored via CP1 and CP2.

The signal from the “bright” port is amplified by LNA1 and LNA2 before splitting by CP3 into two parts: one part is injected into the VCO to complete the DSIL loop. The other part goes directly into a DBM to mix with the signal from the “dark” port after it is amplified by LNA3 to obtain a voltage signal related to the VCO phase noise, which is then amplified and filtered by an LPF before being fed to the VCPS inside the VCO of FIG. 4A. The phase noise and spectrum of the noise-suppressed VCO output are measured using a phase noise/spectrum analyzer via coupler CP4.

To evaluate the effects of the DSIL loop alone, the CSI-SPL loop in FIG. 5B is first made open by disconnecting the output of the LPF to the voltage control port of the self-built low-quality VCO (VCPS' input port), while only closing the DSIL loop. By adjusting the VA and MPS1 in FIG. 5B, the two signals with different delays entering the 3-dB coupler can be equalized while the total injection power to the VCO can be maximized due to the constructive interference at the 3-dB coupler.

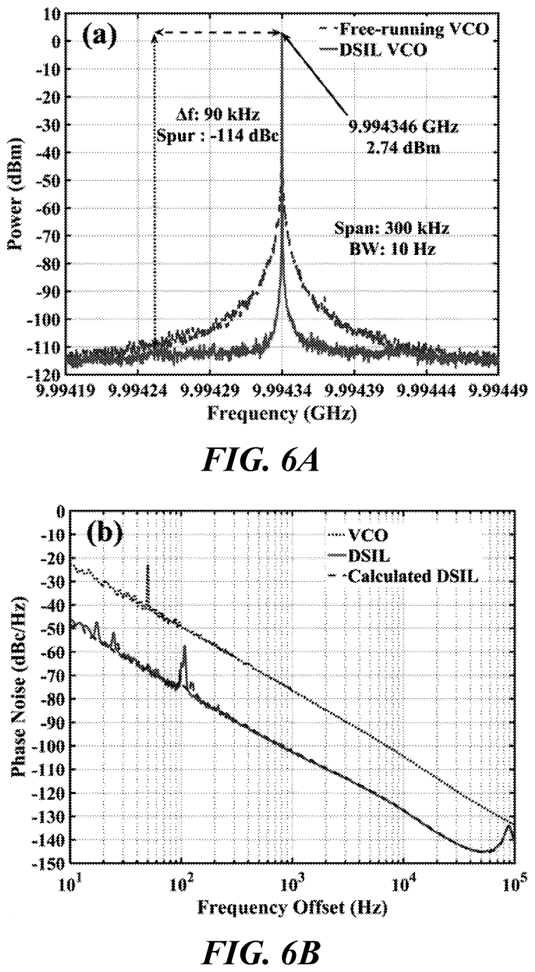

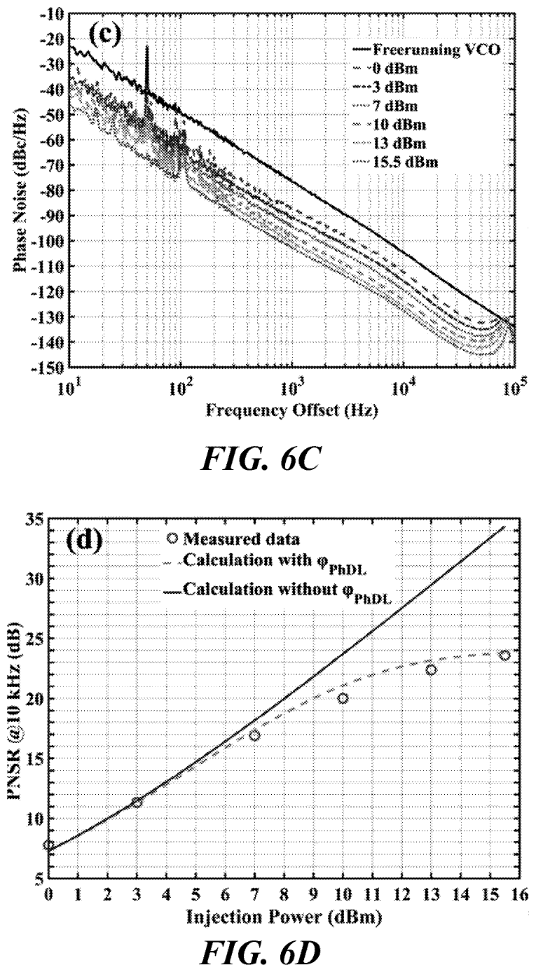

FIG. 6A shows the RF spectra of the VCO with (red) and without (blue) closing the DSIL loop, demonstrating a significant reduction of the side wings of the signal spectrum. The small bumps in FIG. 6A at ±90 kHz offset relate to the free spectral range (FSR) of the DSIL loop, which is more than −114 dB down from the carrier, indicating a spur of less than −114 dB.

FIG. 6B shows the corresponding phase noise curves of the VCO with (red) and without (black) the DSIL noise reduction. The phase noises of the DSIL-VCO are suppressed by 26 dB and 23 dB, respectively, at 1 KHz and 10 kHz from the carrier, as compared with those of the free-running VCO, resulting in respectful phase noise levels of −103 dBc/Hz and −128 dBc/Hz at 1 kHz and 10 kHz frequency offsets, respectively, when the DSIL loop is closed. It can also be seen that the measured phase noise curve of the DSIL-VCO in FIG. 6B agrees well with that of the calculated curve using Laplace domain phase noise model of Eq. (3), with the following measured parameters: ρ=3.31, Δf=6.097 MHz, τ₁ and τ₂ corresponding to the delays of optical fibers with lengths of 2.15 km and 200 m, respectively, and a refractive index of 1.456.

To evaluate the effect of the injection power Pᵢₙⱼ on the phase noise of the DSIL-VCO, an RF attenuator was placed before the VCO's injection port to control the injection power into the VCO. FIG. 6C shows the measured phase noise curves of the DSIL-VCO at different injection powers at 15.5 dBm, 13 dBm, 10 dBm, 7 dBm, 3 dBm, and 0 dBm, respectively, with 15.5 dBm being the maximum power that could be injected without causing oscillation. Because the K_{I} of the DSIL is proportional to the ratio of the injection power Pᵢₙⱼ over the VCO oscillating power P_{osc} (K_{I}∝Pᵢₙⱼ/P_{osc}), as discussed in the text above Eq. (2), the phase noise is expected to decrease as Pᵢₙⱼ increases, agreeing well with the experimental results.

FIG. 6D shows the measured phase noise suppression ratio (PNSR) of the DSIL-VCO at a 10 KHz frequency offset extracted from FIG. 6C compared with the calculated PNSRs obtained from Eq. (3) with and without φ_{PhDL}. It can be seen that the PNSR initially increases linearly with the injected power. However, when the injected power is over 10 dBm, the slope of the curve starts to decrease significantly, agreeing well with the calculation of Eq. (3), which indicates that the phase noise contribution from the PhDL starts to limit the phase noise reduction of the DSIL loop. Without this limitation, as shown by the blue curve (ignoring (PhDL), the PNSR would continue to increase linearly with the injected power.

In the experiment discussed above, the CSI-SPL loop was kept open while only the DSIL loop was active, resulting in a maximum phase noise reduction of 23 dB at 10 kHz offset, approaching the limit set by the noises in the PhDL. To further reduce the VCO's phase noise, tests were conducted by closing the CSI-SPL loop while the DSIL loop stays closed. In operation, the error signal from the DBM is fed to the VCO's control port after being filtered and amplified by the LPF circuit. Note that MPS1 and VA in FIG. 5B must be carefully adjusted to suppress the output power from the “dark” port of the 3-dB coupler, with a carrier suppression ratio typically greater than 40 dB. Additionally, MPS2 must be adjusted to ensure a 0° or 180° phase difference between the two signals entering DBM for amplitude noise detection, while the bandwidth and the gain of the LPF must be appropriately selected. In the experiment, a carrier suppression of about 45 dB can be maintained due to the action of the DSIL, and the bandwidth and gain of the LPF are set to 1 MHz and 26 dB, respectively.

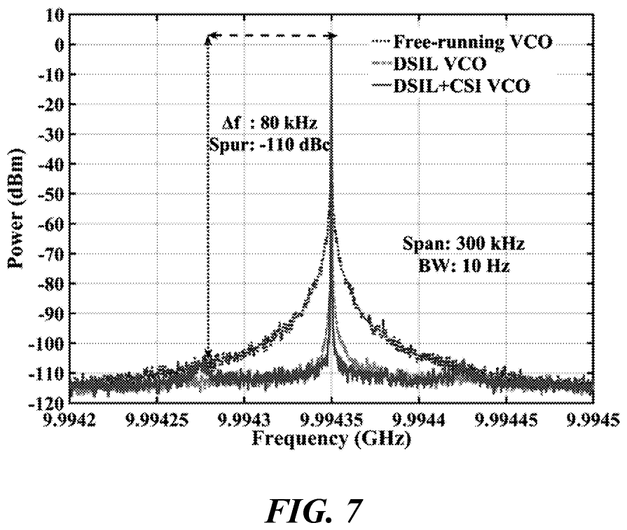

With the adjustments described above, the side-wings of the VCO signal are further cleaned up, as shown in FIG. 7, with the red curve measured using the spectrum analysis function of the PNA (R&S FSWP-26). As a comparison, the spectra of the free-running VCO and the VCO with only the DSIL phase noise reduction are also shown. Note that the spurs due to the CSI-SPL loop length are slightly (4 dB) higher compared to that due to the DSIL loop shown in FIG. 6A, resulting in a spur level of −110 dBc.

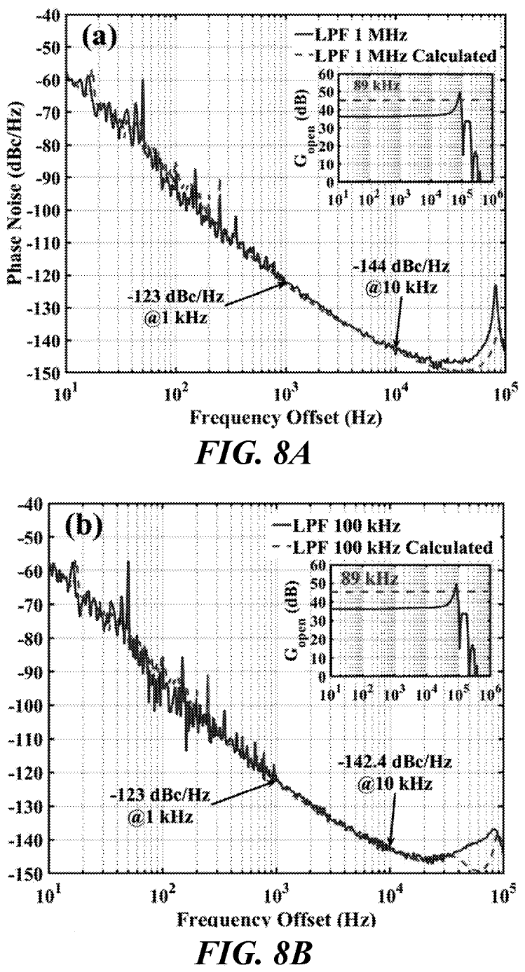

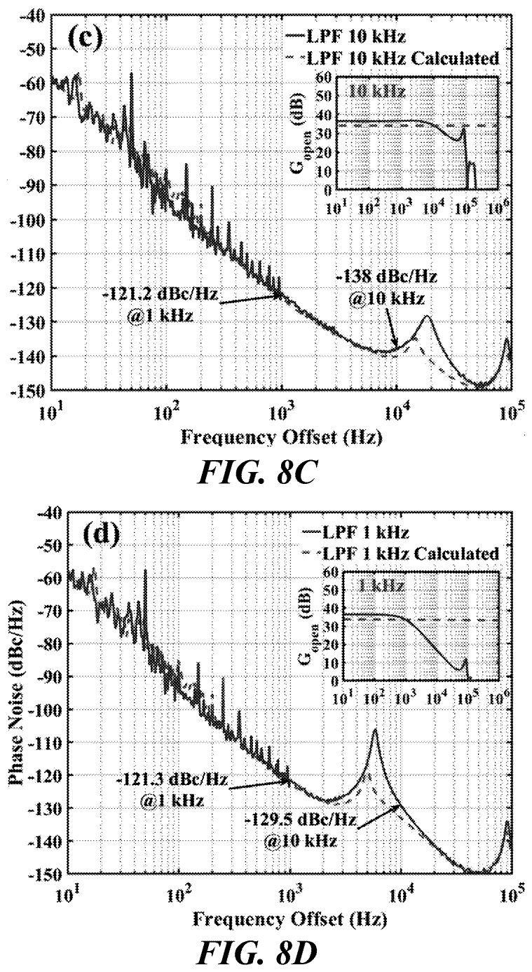

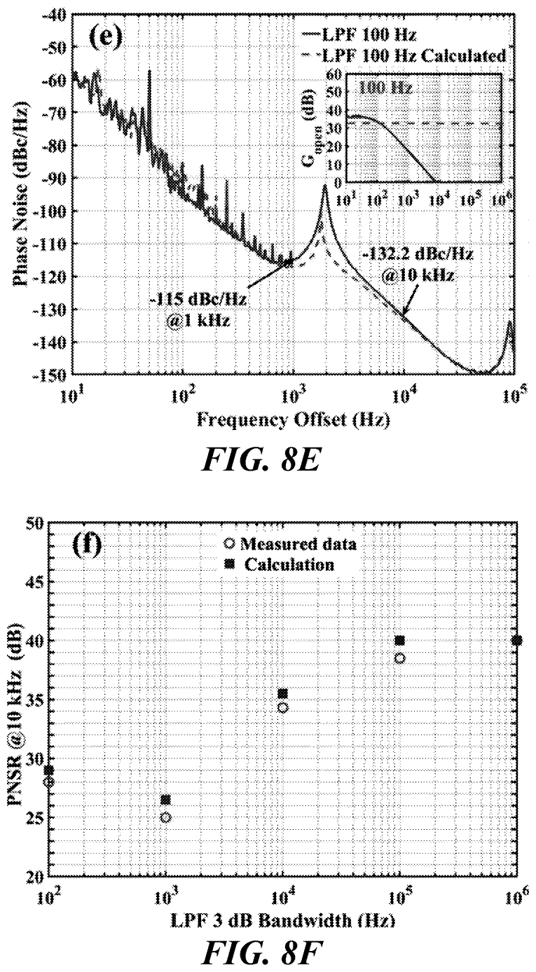

The phase noise of the VCO signal in FIG. 7 with the joint DSIL and CSI-SPL noise reduction is measured using the PNA (R&S FSWP-26), with the result shown with the blue curve in FIG. 8A. It can be seen that the phase noises are further reduced to −123 dBc/Hz and −144 dBc/Hz at 1 kHz and 10 kHz away from the carrier, respectively, which represents 20 dB and 16 dB further down from the levels obtained with the DSIL noise reduction alone at 1 KHz and 10 KHz frequency offset, respectively, or a total phase noise reduction of 46 dB and 39 dB from those of the free-running VCO. The red curve in FIG. 8A is the calculated result using Eq. (6), agreeing well with the measured result (blue curve). Here ρ, Δf, τ₁ and τ₂ are the same as those in FIGS. 6A, 6B, 6C, and 6D; Gₒₚₑₙ=|G_{CSI}(e^{-sτ}^{₁}−e^{-sτ}^{₂})| is the measured open-loop gain of the CSI-SPL feedback loop, including the LPF with a bandwidth of 1 MHz and a gain of 26 dB).

The noise reduction bandwidth of the joint DSIL and CSI-SPL scheme is not only determined by that of the LPF but also by the fiber delays in the PhDL, as shown in FIG. 8A. It can be seen that although the LPF bandwidth is set at 1 MHz, the noise reduction bandwidth is limited to about 80 kHz where a noise bump around −122 dBc/Hz arises, agreeing reasonably well with the calculation (red curve). The slight discrepancy is probably due to the inaccuracies of the parameters used in the calculation.

To further demonstrate the effectiveness of our noise reduction scheme and validate our analysis results of Eq. (5), different LPF bandwidths in the CSI-SPL loop are chosen, with the measured phase noise curves of the VCO deploying DSIL and CSI-SPL loops shown in FIGS. 8B to 8E, corresponding to LPF cutoff frequencies of 100 kHz, 10 kHz, 1 kHz, and 100 Hz, respectively. The inset in each figure of FIGS. 8A, 8B, 8C, 8D, 8E, and 8F shows the corresponding open-loop gain Gₒₚₑₙ as a function of the frequency of the CSI-SPL loop measured using the Bode plot function of an oscilloscope (Rohde & Schwarz RTB2004), which corresponds to Gₒₚₑₙ=|G_{CSI}(e^{-sτ}^{₁}−e^{-sτ}^{₂})| in Eq. (5).

The measured phase noise curves obtained via our measurements agree with the analytical results reasonably well. The locations of the bumps on the phase noise curves in FIGS. 8B to 8E are primarily determined by the LPF but influenced by the fiber lengths in the feedback loops, beyond which the CSI-SPL is no longer effective. To avoid the phase noise bumps in the offset frequency range of interest and maximize the noise reduction effect of the CSI-SPL loop, the LPF bandwidth should be larger than the free spectral range (FSR) determined by the loop lengths.

FIG. 8F shows the comparison of the measured (red circles) and the calculated (blue dots) phase noise suppression ratios (PNSR) of the VCO at different 3 dB bandwidths of the LPF using the data extracted from FIGS. 8A to 8E, with reasonable agreement. Note that open-loop gain Gₒₚₑₙ bandwidths of the CSI-SPL loop when LPF is set at 100 kHz and 1 MHz are identical at 89 kHz, determined primarily by the FSR of the loop, with the measured PNSR differs by only 1.5 dB.

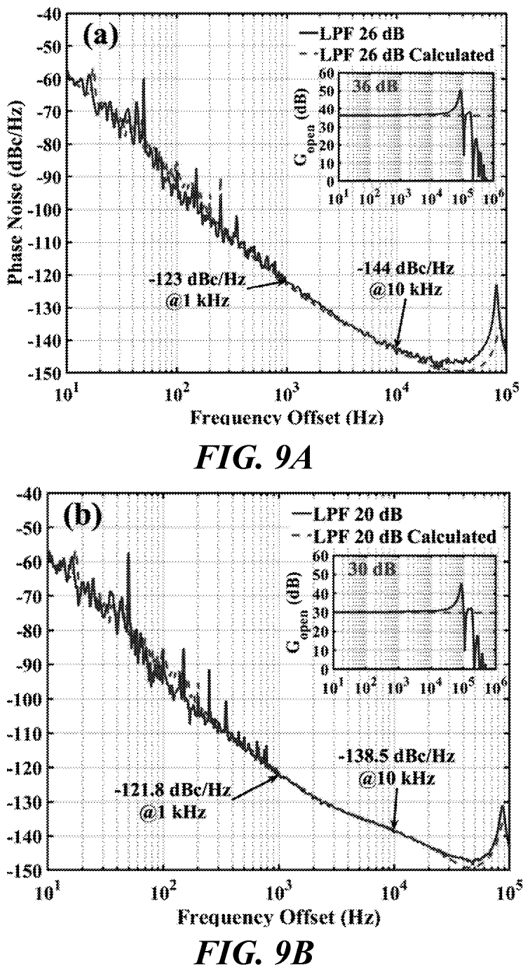

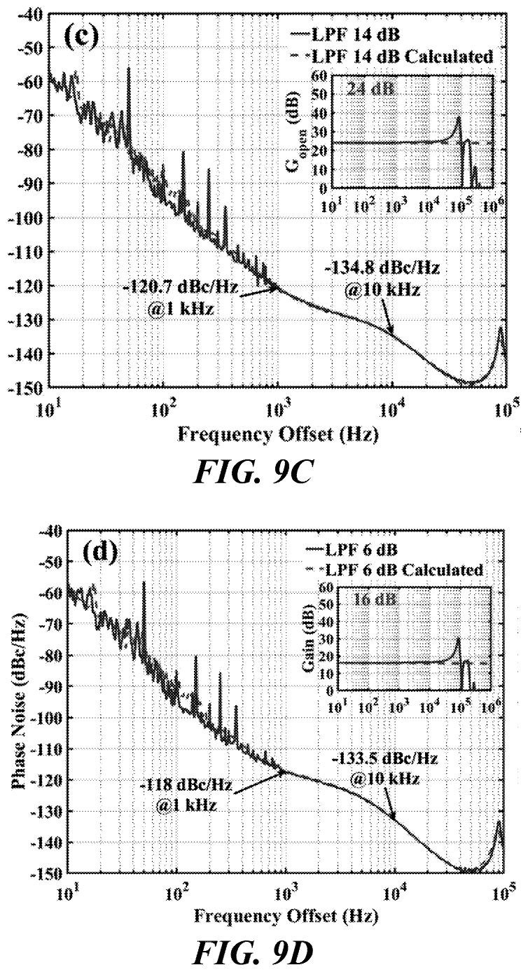

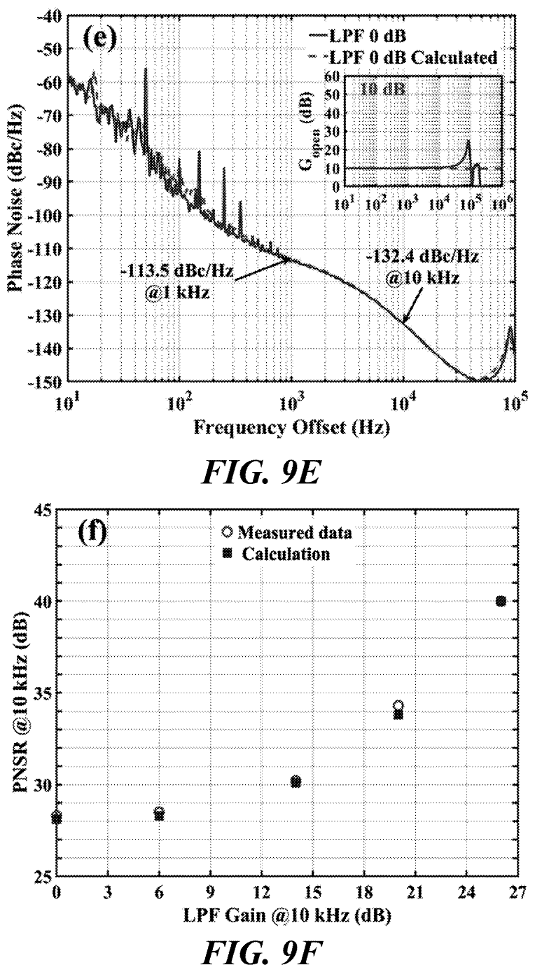

FIGS. 9A through 9E are the measured phase noise curves (blue line) showing the relationship between the VCO phase noise and the LPF gain, which is set at 26 dB, 20 dB, 14 dB, 6 dB, and 0 dB, respectively, corresponding to the open loop gains Gₒₚₑₙ of the CSI-SPL loop of 36 dB, 30 dB, 24 dB, 16 dB, and 10 dB measured using the Bode plot function Rohde & Schwarz RTB2004 oscilloscope, as shown in the inset of each figure. Again, these phase noise curves agreed with our analytical results of Eq. (5) (red lines) very well. As can be seen, the VCO phase noise in the offset range from 1 kHz to 10 kHz decreases proportionally with the loop gain, while remains constant in the offset range close to the carrier from 10 Hz to 100 Hz, indicating that in this offset range the phase noise is limited by the noise S_{φ}_{ₙ} in the LPF circuit, as discussed in the text above Eq. (6). At 10 kHz offset from the carrier, the phase noise suppression of the VCO with combined DSIL and CSI-SPL is about 40 dB from the free-running VCO and 10 dB from the DSIL-VCO. FIG. 9F shows the comparison of the measured and the calculated phase noises of the VCO with the joint DSIL and CSI-SPL noise reduction scheme at 10 kHz offset at different LPF gains using the data extracted from FIGS. 9A to 9E, with excellent agreement.

The disclosed VCOs with PhDL enabled joint DSIL and CSI-SPL can be used to achieve VCO operations at different noise levels and frequencies. In principle, the PhDL enabled joint DSIL and CSI-SPL scheme can be applied to VCOs operating at any RF frequency with any phase noise levels. To demonstrate this applicability, we replaced the BPF centered at 10 GHz in the VCO of FIG. 4A with a BPF centered at 8.835 GHz and a bandwidth of 102 MHz.

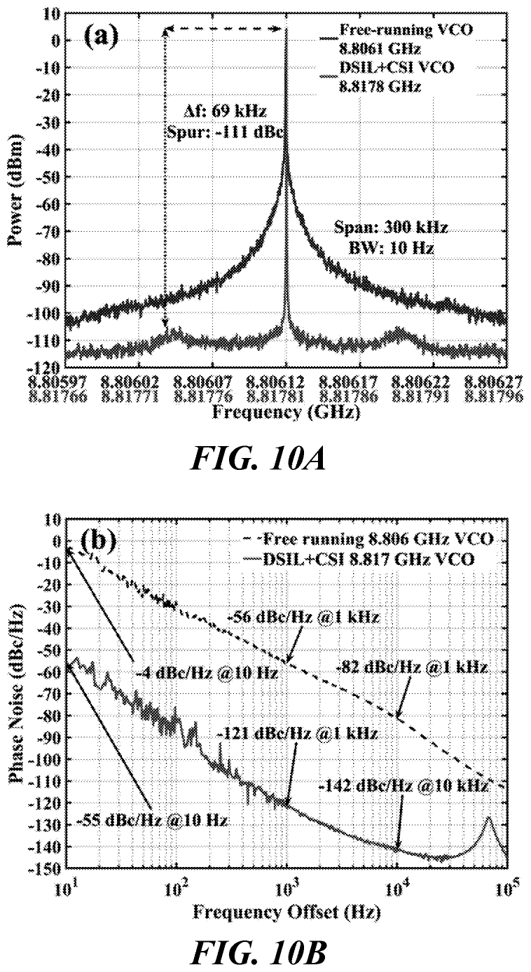

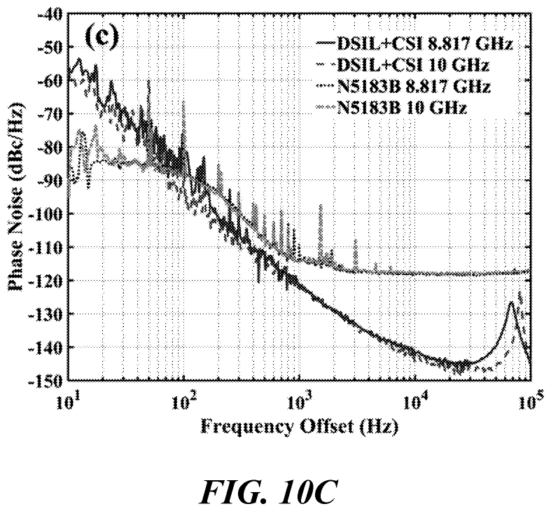

The spectrum of the free-running VCO is shown by the blue curve in FIG. 10A with a center frequency of 8.806 GHz, while the corresponding phase noise curve is presented by the black line in FIG. 10B, showing a phase noise of −56 dBc/Hz at 1 KHz and −82 dBc/Hz at 10 kHz from the carrier. Compared to the free-running 10 GHz VCO of FIG. 4A, the phase noise of the 8.806 GHz deteriorated due to the increase of the bandwidth (102 MHz vs. 12 MHz) or decrease of the Q-factor of the BPF. By applying the PhDL-enabled joint DSIL and CSI-SPL noise reduction scheme, the phase noise of the free-running signal is greatly suppressed, resulting in the spectrum curve (red) in FIG. 10A and the phase noise curve (red) in FIG. 10B.

As can be seen from FIG. 10A, the center frequency of the VCO is pulled by 11.7 MHz to 8.8178 GHz by closing the noise reduction loops. There also appeared two slight noise humps at +69 kHz offset with a height of 111 dB down from the carrier in the spectrum of the noise reduced VCO of FIG. 10A. In addition, as can be seen from FIG. 10B, huge phase noise reductions of over 51 dB, 65 dB, and 60 dB at 10 Hz, 1 kHz, and 10 kHz are achieved with our DSIL assisted CSI-SPL noise reduction scheme, which is even larger than those of the VCO at 10 GHz shown in FIG. 8A. The final phase noises obtained are −55 dBc/Hz, −121 dBc/Hz, and −142 dBc/Hz at 10 Hz, 1 kHz, and 10 kHz, respectively.

Finally, FIG. 10C compares the phase noises of the phase noise reduced VCOs at 10 GHz (red) and 8.817 GHz (blue), showing that the final achieved phase noise levels are similar, despite the huge phase noise difference of the free-running VCOs (−77 dBc/Hz vs. −56 dBc/Hz and −105 dBc/Hz vs. −82 dBc/Hz at 1 kHz and 10 kHz offsets, respectively). It should be noted that the locations and sizes of the noise bumps of the noise reduced VCOs at 8.817 GHz and 10 GHz are slightly different (69 kHz and −126 dBc/Hz vs. 80 kHz and −122 dBc/Hz) in FIG. 10C due to the difference in the open loop gains of the two VCOs with the noise reduction loops, including the contributions of the VCO Q-value and the gain and bandwidth of the LPF, although the fiber delays remain unchanged. In the experiment, excessive open loop gain may result in a higher noise bump in the phase noise curve and therefore the gain and the bandwidth of the LPF (300 kHz, 20 dB) need to be controlled to balance the phase noise reduction and the heights of the noise bumps.

FIG. 10C also compares the phase noises of signals at 8.817 GHz and 10 GHz from the VCOs with DSIL assisted CSI-SPL reduction and signals at 8.817 GHz and 10 GHz generated by a commercial microwave signal source (Keysight N5183B). At frequency offsets greater than 1 kHz, the phase noise of the noise reduced VCO is much lower than that of the N5183B. Close to the carrier at a frequency offset below 60 Hz, the phase noise of the N5183B is lower. However, in applications, the VCO with joint DSIL and CSI-SPL noise reduction can be phase-locked to a system reference source to reduce its close-in phase noise while increasing its long-term stability⁶.

The above disclosed combination of the PhDL-enabled dual loop self-injection locking and CSI self-phase locking techniques for phase noise suppression was demonstrated to successfully transform a low-quality and noisy 10 GHz VCO into a high-performance RF source with ultra-low phase noises of −123 dBc/Hz@1 kHz and −144 dBc/Hz@10 kHz, corresponding to phase noise reductions of 46 dB at 1 kHz and 39 dB at 10 kHz respectively. Even larger phase noise reductions of 65 dB and 60 dB at 1 KHz and 10 KHz frequency offsets were also achieved with a VCO of higher phase noise at 8.806 GHz. In addition, ultra-low spurs of less than −110 dB have also been achieved with these ultra-low phase noise RF sources⁶. The DSIL is for the initial phase noise reduction while establishing a favorable condition for the CSI-SPL to remove PhDL's phase noise contributions to the system. Further phase noise reduction using longer optical fibers in PhDL without increasing side mode spurs is expected. Additionally, tests were conducted to apply the Laplace domain phase noise analysis model for the DSIL assisted CSI-SPL phase noise reduction scheme to accurately predict phase noise suppressions under different bandwidths and feedback loop gains. The calculated results and the associated analysis model can be used for optimizing system parameters. The disclosed PhDL-enabled dual loop self-injection locking and CSI self-phase locking techniques can be used to lift the phase noise limitation imposed by the phase noise contributions from the PhDL for various applications for making high-performance RF sources from low-cost RF oscillators at frequencies up to 220 GHz and beyond, limited by the modulator's speed in the PhDL, which can be readily applied to on-chip OEOs fabricated using photonic integration³³⁻³⁶, in addition to the low cost RF oscillator ICs. The latest advancements of photonic integrated TFLN modulator chips^{32,37-39} and reduced-cladding optical fibers with a total diameter of 125 μm or less⁴⁰ warrant that low-cost and compact PhDLs can be made to support the commercial realization of such high-performance RF sources.

In various experiments conducted with 2.15 km and 0.2 km optical fibers in the two arms of the CSI, we successfully reduced the phase noises of self-built low-cost X-band VCOs by up to 65 dB and 60 dB, achieving ultra-low phase noises down to −123 dBc/Hz and −144 dBc/Hz at 1 kHz and 10 kHz, respectively, from the carrier, with a spur of only −110 dB. Further phase noise reduction using longer optical fibers without increasing side mode spurs is expected. We also developed and experimentally validated a Laplace domain phase noise analysis model for better understanding the phase noise reduction system and optimizing system parameters. The disclosed technology provides an attractive pathway for reducing phase noise of VCOs, including on-chip optoelectronic oscillators, and for transforming various low-cost noisy VCOs into ultra-low phase noise and ultra-low spur RF sources, and hence revamps the design approaches of high frequency oscillators up to 220 GHz and beyond. The disclosed technology provides a practical and commercially viable way for phase noise reduction of relatively noisy VCOs to achieve desired low phase noise levels at various frequencies including the V-band and other frequency bands.

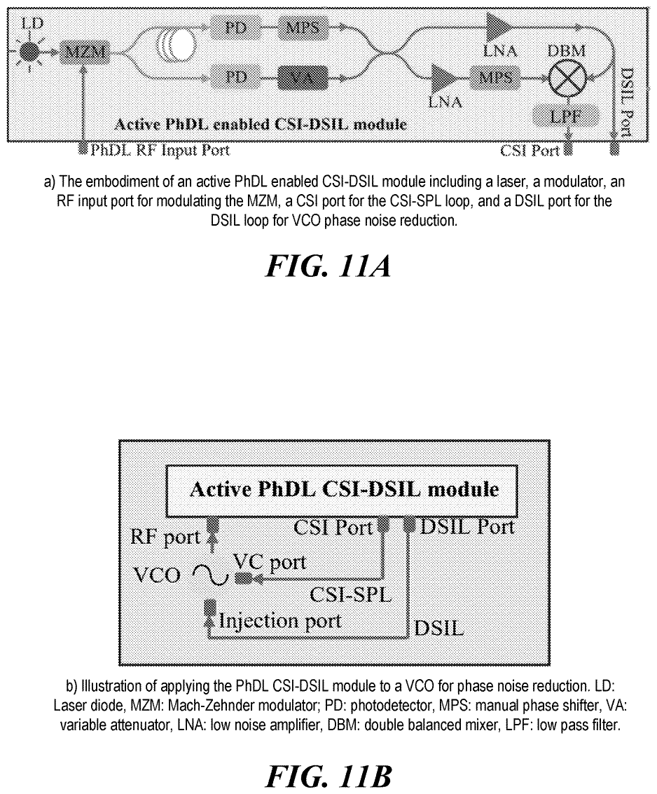

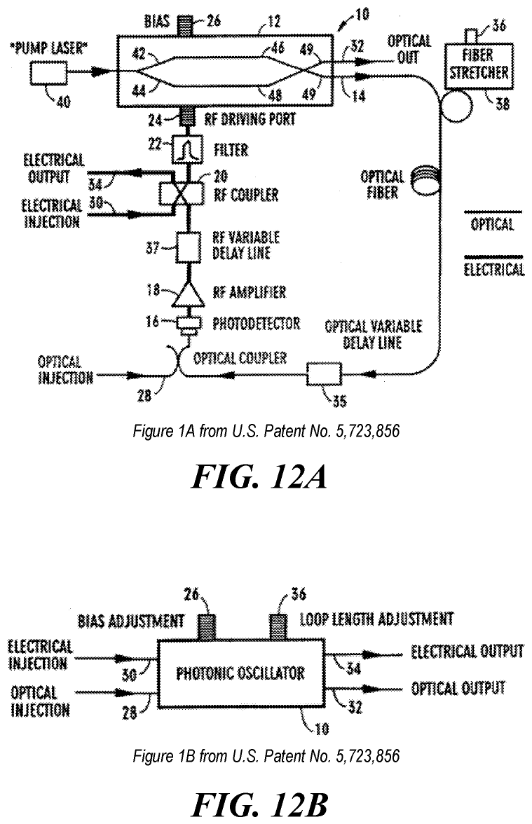

FIGS. 11A and 11B show an example of a general purpose active PhDL enabled CSI-DSIL module based on the features in FIGS. 3A and 3B. This module has 3 ports to interface a VCO and can be used to achieve a high-performance VCO for phase noise reduction by first connecting the RF output port of the VCO to the PhDL RF input port to drive the MZM, and then connecting the DSIL port and the CSI port on the PhDL module to the injection port and the voltage control (VC) port of the VCO, respectively, to close the CSI-SPL loop and the DSIL loop.

Voltage controlled oscillators can be implemented in various configurations, including, for example, the classic electrical VCOs constructed by all electrical circuits and components for generating RF or microwave oscillation signals. Some examples of such electrical VCOs may use a LC oscillation circuit as a frequency selective circuit element, a crystal oscillator circuit with a piezoelectric crystal, a Gunn oscillator circuit by using a Gunn diode with a negative differential resistance, a resonant cavity, and a bias circuit, or a ring oscillator circuit (e.g., the X-band VCO in FIG. 4A) for turning the oscillator frequency or as the frequency selective circuit element. Majority of commercial available VCOs are electrical VCOs such as VCO chips and products by Analog Devices, Inc., Z-Communications, MACOM and may others. The disclosed techniques in this patent document can be used to reduce the phase noise of such electrical VCOs by using the combination of the CSI-SPL loop to control the control voltage of the VCOs and the DSIL loop for injection locking of the VCOs.

The noise reduction design in FIGS. 11A and 11B can also be adopted and applied to another type of voltage-controlled oscillators: opto-electronic Oscillators (OEOs) that provide an optical-electrical hybrid closed loop to include an optical loop section with electrically controlled optical modulation and an electrical loop section to sustain an electrical oscillation at a radio frequency or microwave frequency. Specifically, such an OEO's optical loop section includes an electrically controllable optical modulator that receives input light such as laser light to produce a modulated optical output, and a photodetector that interconnects the optical loop section and the electrical loop section to receive the modulated optical output from the optical modulator and to convert the modulated optical output into an electrical signal in the electrical loop section which in turn applies an electrical control signal to control the optical modulator so that the modulated optical output is modulated to carry an electrical RF or microwave oscillation signal at a desired radio frequency or microwave frequency. Notably, the optical-electrical hybrid closed loop is structured to feed the electrical signal in phase to the optical modulator to generate and sustain both optical modulation and electrical oscillation at the desired radio frequency or microwave frequency and is a VCO which can tune the radio frequency or microwave frequency of its electrical oscillation by adjusting a control voltage that is applied in the optical-electrical hybrid closed loop. OEOs are known for their unique properties or characteristics, including low phase noise, spectral purity or narrow spectral width, immunity to electromagnetic (EM) interference, sharp falloff in the frequency domain, availability of signal processing via optical processing and optical transmission in the optical domain without limitations for circuit components, among others.

The following sections first provide an overview of OEOs and the describe examples of reducing the phase noise of OEOs by using the combination of the CSI-SPL loop to control the control voltage to the OEOs and the DSIL loop for injection locking of the OEOs.

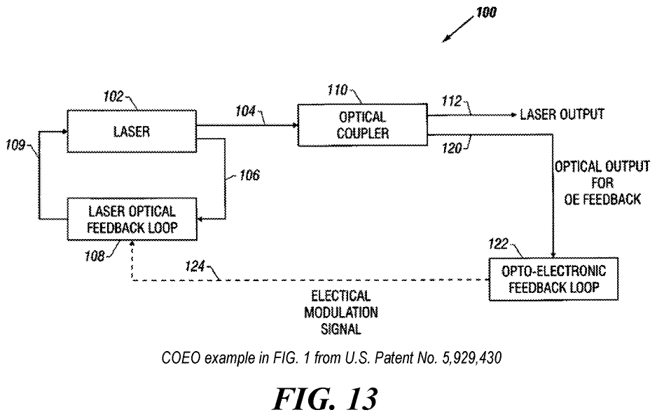

Various OEO configurations have been developed including the pioneering OEO work by the inventor of this patent document. U.S. Pat. Nos. 5,723,856 and 5,777,778 provide examples of single-loop OEOs and multi-loop OEOs. FIGS. 12A and 12B show an example of an OEO in FIGS. 1A and 1B of U.S. Pat. No. 5,723,856. Such an OEO may include an electric-optical modulator having an electrical input port that accepts an electrical control signal and an optical output port, wherein the electric-optical modulator is operable to generate at the optical output port an optical signal being modulated at an oscillation frequency related to the electrical control signal; a photodetector operable to convert a portion of the optical signal from the optical output port of the electro-optical modulator to an electrical signal and to provide the electrical signal to the electrical input port of the electro-optical modulator as the electrical control signal, wherein the electrical signal from the photodetector oscillating at the same oscillation frequency at which the optical signal at the optical output port is modulated; and an active feedback loop connecting the optical output port, wherein the photodetector and the electrical input port, the feedback loop having a positive feedback with an open loop gain which is greater than one.

The optical part of the opto-electronic feedback loop can include an optical delay element to produce an optical delay which constitutes a part of, or the majority of the total delay produced by the feedback loop. The optical delay element can be implemented in various configurations. For example, OEOs may be constructed by including optical resonators in the OEO loops as disclosed in U.S. Pat. No. 6,567,436 in which various forms of optical resonators may be used including optical whispering gallery mode resonators (e.g., U.S. Pat. Nos. 6,389,197 and 6,795,481) and other compact resonators such as integrated ring resonators for forming integrated opto-electronic oscillators having optical resonators (e.g., U.S. Pat. No. 6,873,631).

The optical part of the opto-electronic feedback loop can include an optical delay element to produce an optical delay which constitutes a part of, or the majority of the total delay produced by the feedback loop. The optical delay element can be implemented in various configurations. Notably, a high-Q optical resonator may be used as the optical delay element and be disposed in the optical part of the opto-electronic feedback loop or in another optical feedback loop coupled to the opto-electronic feedback loop, to provide a sufficiently long energy storage time and an optical filtering mechanism to produce an oscillation of a narrow linewidth and low phase noise. The mode spacing of the optical resonator is equal to one mode spacing, or a multiplicity of the mode spacing, of the opto-electronic feedback loop. In addition, the oscillating frequency of the OEO is equal to one mode spacing or a multiple of the mode spacing of the optical resonator. The U.S. Pat. No. 6,567,436 describes examples of OEOs with at least one optical resonator in the optical part of the opto-electronic feedback loop. The optical resonator may be implemented in a number of configurations, including, e.g., a Fabry-Perot resonator, a fiber ring resonator, and an optical resonator operating in one or more whispering-gallery modes (WGMs) such as microsphere, microdisk, and microring WGM resonators.

Another type of OEOs is coupled opto-electronic oscillators (“COEOs”) described in U.S. Pat. No. 5,929,430. Such a COEO directly couples a laser oscillation in an optical feedback loop to an electrical oscillation in an opto-electronic feedback loop. A multi-mode laser can be used. A COEO can include a laser, having an internal active optical feedback loop with a first loop gain greater than unity and responsive to an electrical modulation signal, said laser operating to produce a coherent optical oscillation; and an opto-electronic feedback loop with a second loop gain greater than unity, receiving an optical signal indicative of said optical oscillation and converting said optical signal into said electrical modulation signal having a relation with said optical oscillation, said electrical modulation signal affecting said optical loop and said optical oscillation.

FIG. 13 shows an example of a COEO in FIG. 1 from U.S. Pat. No. 5,929,430. The laser oscillation and the electrical oscillation are correlated with each other so that both the modes and stability of one oscillation are coupled with those of the other oscillation. The optical feedback loop includes a gain medium to produce a loop gain greater than unity to effectuate the laser oscillation. This optical loop may be a Fabry-Perot resonator, a ring resonator, other resonator configurations. The open loop gain in the opto-electronic loop also exceeds the loss to sustain the electrical oscillation. The coupling between two feedback loops is achieved by controlling the loop gain of the optical loop by an electrical signal generated by the opto-electronic feedback loop. COEOs can achieve a single-mode RF oscillation without a RF bandpass filter or any additional opto-electronic feedback loops.

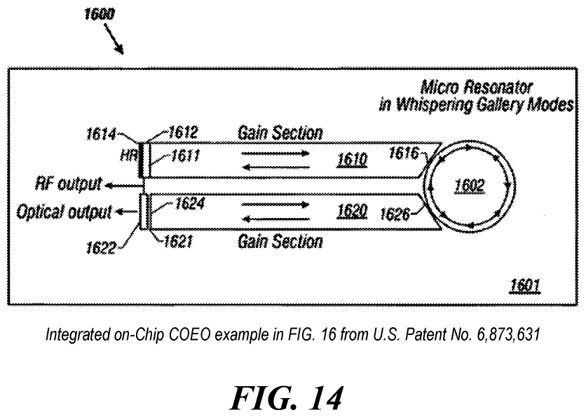

FIG. 14 shows another example of a coupled optoelectronic oscillator (COEO) that is integrated on a chip as shown in FIG. 16 from U.S. Pat. No. 6,873,631. The microsphere is an example micro-resonator. Other types of micro-resonators can also be used. The oscillation frequency can be tuned by tuning the resonant frequency of the micro-resonator by changing an operating condition of the micro-resonator, e.g., applying a voltage on the resonator that exhibits an opto-electro effect to change a refractive index of the resonator, a mechanical force to change a dimension of the resonator, or by changing its temperature. The COEO can be formed over a substrate such as a semiconductor substrate and can include a semiconductor optical modulator formed on the substrate to modulate an optical beam in response to an electrical modulation signal. The COEO in FIG. 14 includes a first waveguide formed on the substrate having a first end that is to receive a modulated optical signal from the optical modulator, and a second end that has an angled facet coupled to the micro-resonator via evanescent coupling, a second waveguide formed on the substrate and having a first end with an angled facet which is coupled to the microresonator via evanescent coupling, and a semiconductor photodetector formed on the substrate to receive and convert an optical output from the second waveguide into an electrical signal. In addition, an electrical link is formed on coupled between the photodetector and the optical modulator to produce the electrical modulation signal from the electrical signal. At least part of the first and second waveguides is doped to produce an optical gain to produce a laser oscillation in a laser cavity formed by the optical waveguides and the microresonator.

The COEO in FIG. 14 is an integrated COEO that includes a high-Q optical resonator in an electrically controllable feedback loop. An electro-optical modulator is provided to modulate an optical signal in response to at least one electrical control signal. At least one opto-electronic feedback loop, having an optical part and an electrical part, is coupled to the electro-optical modulator to produce the electrical control signal as positive feedback. The electrical part of the feedback loop converts a portion of the modulated optical signal that is coupled to the optical part of the feedback loop into an electrical signal and feeds at least a portion of it as the electrical control signal to the electro-optical modulator. The high-Q optical resonator may be disposed in the optical part of the opto-electronic feedback loop or in another optical feedback loop coupled to the opto-electronic feedback loop, to provide a sufficiently long energy storage time and hence to produce an oscillation of a narrow linewidth and low phase noise. The mode spacing of the optical resonator is equal to one mode spacing, or a multiplicity of the mode spacing, of the opto-electronic feedback loop. In addition, the oscillating frequency of the OEO is equal to one mode spacing or a multiple of the mode spacing of the optical resonator. The optical resonator may be implemented in a number of configurations, including, e.g., a Fabry-Perot resonator, a fiber ring resonator, and a microsphere resonator operating in whispering-gallery modes. These and other optical resonator configurations can reduce the physical size of the OEO devices and allow integration of an OEO with other photonic devices and components in a compact package such as a single semiconductor chip. Various additional examples of integrated OEO designs (including COEO designs) can be found in U.S. Pat. No. 7,480,425.

OEOs can also be implemented by having at least one active opto-electronic feedback loop that generates an electrical modulation signal based on the stimulated Brillouin scattering where a Brillouin optical medium is included in the feedback loop to provide a natural narrow linewidth of the Brillouin scattering to select a single oscillating mode (e.g., U.S. Pat. Nos. 5,917,179, 6,417,957 and 6,476,959). OEOs can be used to take an advantage of the optical delay in the optical loop section of the optical-electrical hybrid closed loop to suppress phase noise in RF or microwave oscillation signals (e.g., U.S. Pat. No. 6,580,532).

Each of the above-mentioned U.S. patents is incorporated by reference and is listed below.
1: U.S. Pat. No. 5,723,856;
2: U.S. Pat. No. 5,777,778;
3: U.S. Pat. No. 5,723,856;
4: U.S. Pat. No. 6,567,436;
5: U.S. Pat. No. 6,389,197;
6: U.S. Pat. No. 6,795,481;
7: U.S. Pat. No. 6,873,631;
8: U.S. Pat. No. 5,929,430;
9: U.S. Pat. No. 7,480,425;
10: U.S. Pat. Nos. 5,917,179,
11: U.S. Pat. No. 6,417,957;
12: U.S. Pat. No. 6,476,959; and
13: U.S. Pat. No. 6,580,532.

The performance of the above and other OEOs as VCOs can be further improved by using the disclosed techniques in this patent document to reduce the phase noise of the OEO-generated electrical oscillation signal output based on the combination of the CSI-SPL loop to control the control voltage of the OEO and the DSIL loop for injection locking of the OEO.

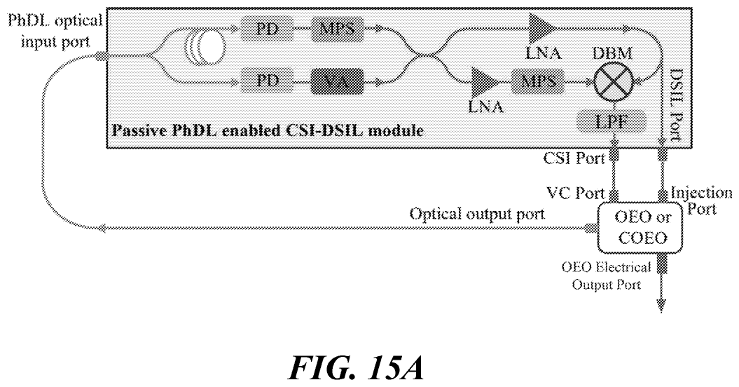

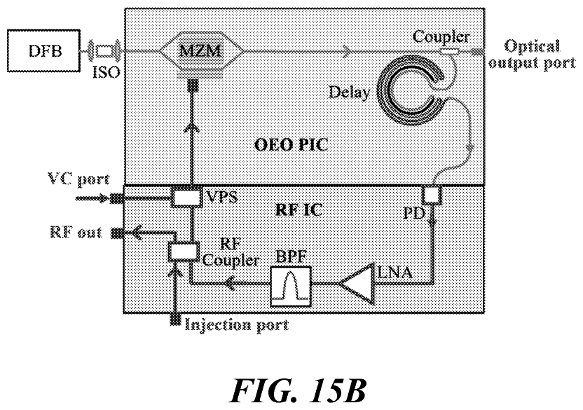

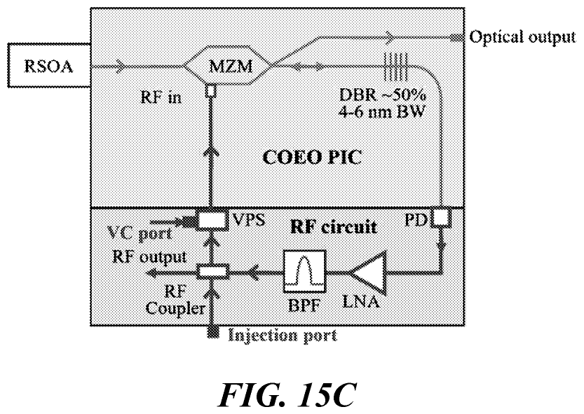

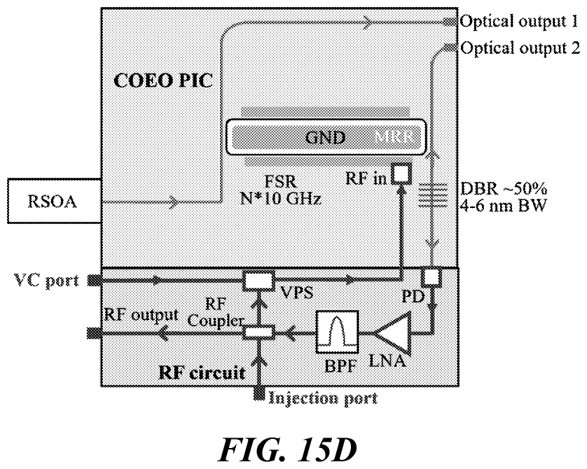

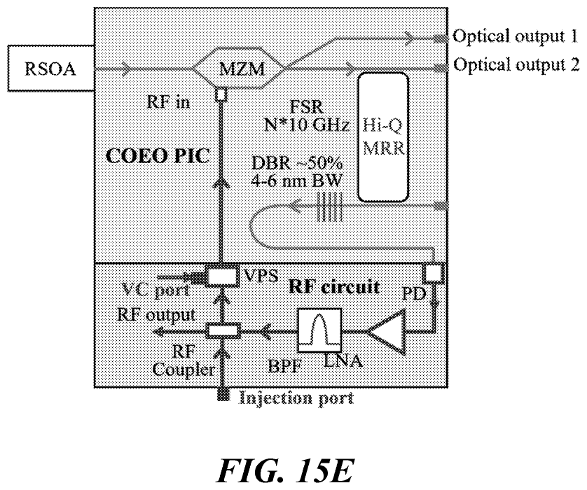

One convenience for using PhDL for OEO phase noise reduction is that no additional laser and modulator are required, since they are already included in the OEO. FIG. 15A shows an example of a passive PhDL enabled CSI-DSIL module without a laser and modulator. In this application as shown in FIG. 15A, an OEO is a 4-port VCO that includes an OEO electrical output port that outputs an electrical oscillation signal at a carrier oscillation frequency (e.g., the electrical output port 34 of the RF coupler 20 in the electrical loop section of the OEO loop in FIG. 12A as reproduced from FIG. 1A in the OEO in U.S. Pat. No. 5,723,856), an OEO electrical injection input port to receive an electrical injection signal (e.g., the electrical injection port 30 of the RF coupler 20 in the electrical loop section of the OEO loop in FIG. 12A as reproduced from FIG. 1A in the OEO in U.S. Pat. No. 5,723,856), an OEO electrical voltage input port to receive an electrical voltage signal (e.g., the electrical input control to the RF variable delay line 37 as a voltage-controlled phase shifter (VPS) in FIG. 12A as reproduced from FIG. 1A in the OEO in U.S. Pat. No. 5,723,856), and an OEO optical output port to output an OEO optical signal (e.g., the optical output port 32 of the optical modulator 12 in FIG. 12A as reproduced from FIG. 1A in the OEO in U.S. Pat. No. 5,723,856).

The OEO as the 4-port VCO can be coupled to the three ports of the module in FIG. 15A: the OEO's optical output is connected to the PhDL's optical input port to supply the modulated optical signal, as shown in FIG. 11A. In addition, the CSI port and the DSIL port of the module in FIG. 15A are connected to the VC port and the injection port of the OEO, respectively. Once connected, the OEO's phase noise in its electrical output oscillation signal can be further reduced. Various OEO designs can be made for coupling to the module in FIG. 15A. Several examples are provided below.

FIG. 15B shows an example of a photonic integrated OEO which includes a DFB laser, an MZM, a length of delay line on the order of few center meters up to 10 meters, a PD, and an RF circuit. The RF circuit includes a low noise amplifier (LNA), a bandpass filter (BPF), an RF coupler, and a voltage-controlled phase shifter (VPS). The injection port and the VC port, labeled with red letters, are to be connected to the PhDL for phase noise reduction. Both the modulator and the delay line can be fabricated with thin film lithium niobate (TFLN). Alternatively, the delay line can be fabricated with silicon nitride (SiN) for low transmission loss. The SiN waveguide can be coupled to the TFLN waveguide via vertical coupling by hybrid integration.

FIG. 15C discloses the first embodiment of a photonically integrated coupled optoelectronic oscillator (COEO) consisting of a reflective semiconductor optical amplifier (RSOA), a MZM, a delay line, a PD, and an RF circuit.

FIG. 15D discloses a second embodiment of a photonic integrated COEO consisting of an RSOA, an active micro-ring resonator (MRR), a distributed Bragg reflector (DBR), a PD, and an RF circuit. The active MRR can be modulated to shift its resonant peak and hence the power of the transmitted light.

FIG. 15E discloses a third embodiment of a COEO consisting of a RSOA, an MZM, a passive MRR, and DBR, a PD, and an RF circuit.

Note that each RF circuit in FIGS. 15B to 15E consists of a low noise amplifier (LNA), a bandpass filter (BPF), an RF coupler, and a voltage-controlled phase shifter (VPS). The Injection port and the VC port of the OEO and COEO are marked in red, to be connected to the PhDL module for phase noise reduction.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

### REFERENCES

1. F. Zou et al., “Optoelectronic oscillator for 5 g wireless networks and beyond,” Journal of Physics D-Applied Physics 54 (42) (2021).
2. F. K. Wang et al., “Review of self-injection-locked radar systems for noncontact detection of vital signs,” Ieee Journal of Electromagnetics Rf and Microwaves in Medicine and Biology 4(4), 294-307 (2020).
3. R. Degl′Innocenti et al., “Recent progress in terahertz metamaterial modulators,” Nanophotonics 11(8), 1485-1514 (2022).
4. R. Adler, “A study of locking phenomena in oscillators,” Proc. IRE 34(6), 351-357 (1946).
5. A. Banerjee et al., “Analysis of injection locking and pulling in single-loop opto-electronic oscillator,” IEEE Trans. Micro-wave Theory Tech. 67(5), 2087-2094 (2019).
6. X. C. Wang and X. S. Yao, “Phase-locked opto-electronic oscillator (oeo) of ultralow phase noise with record-low allan devi-ation of 3.4×10\hat{ }-14 at 1 s,” IEEE Trans. Microwave Theory Tech. 71(12), 5381-5392 (2023).
7. Y. H. Zhu et al., “A novel scheme of microwave generation based on hete-rodyne phase locking of an oeo,” IEEE Photonics Technol. Lett. 28(22), 2637-2640 (2016).
8. C. Heng-Chia et al., “Analysis of oscill-ators with external feedback loop for improved locking range and noise reduction,” IEEE Trans. Microwave Theory Tech. 47(8), 1535-1543 (1999).
9. Z. Zhenghua et al., “An ultra-low phase noise and highly stable optoelectronic oscillator utilizing il-pll,” IEEE Photonics Technol. Lett. 28(4), 516-519 (2016).
10. T. Yoshimura, “Study of injection pulling of oscillators in phase-locked loops,” IEEE Trans. Very Large Scale Integr. VLSI Syst. 29(2), 321-332 (2021).
11. K. C. Peng et al., “An injection- and frequency-locked loop for reducing phase noise of wideband oscillators,” IEEE Trans. Microwave Theory Tech. 66(3), 1374-1383 (2018).
12. C. Heng-Chia, “Stability analysis of self-injection-locked oscillators,” IEEE Trans. Microwave Theory Tech. 51(9), 1989-1993 (2003).
13. C. Heng-Chia, “Phase noise in self-injection-locked oscillators—theory and experiment,” IEEE Trans. Microwave Theory Tech. 51(9), 1994-1999 (2003).
14. J. R. Ashley and C. B. Searles, “Micro-wave oscillator noise reduction by a trans-mission stabilizing cavity,” IEEE Trans. Microwave Theory Tech. 16(9), 743-748 (1968).
15. K. H. Lee et al., “A 30-ghz self-injection-locked oscillator having a long optical delay line for phase-noise reduction,” IEEE Photonics Technol. Lett. 19(21-24), 1982-1984 (2007).
16. K. H. Lee et al., “Low-cost optoelectronic self-injection-locked oscillators,” IEEE Photonics Technol. Lett. 20(13-16), 1151-1153 (2008).
17. L. Zhang et al., “Analytical and experi-mental evaluation of ssb phase noise reduction in self-injection locked oscillators using optical delay loops,” IEEE Photonics J. 5(6), 6602217-6602217 (2013).
18. E. Ayranci et al., “Enhancement of vco linearity and phase noise by implementing frequency locked loop,” in Proc. Int. Conf. ‘Computer as a Tool’-EUROCON, pp. 2593-2599, IEEE, (2007).
19. L. Zhang et al., “Comparison of optical self-phase locked loop techniques for frequency stabilization of oscillators,” IEEE Photonics J. 6(5), 1-15 (2014).
20. J. M. Avila-Ruiz et al., “Ultra-wideband vco phase-noise reduction loop based on a six-port phase-shifterless delay-line discri-minator,” IEEE Trans. Microwave Theory Tech. 62(12), 3076-3084 (2014).
21. Z. Y. Wang et al., “A 4-1 multiplexer-based frequency discriminator used for oscillator phase noise suppression,” IEEE Trans. Microwave Theory Tech. 69(12), 5334-5342 (2021).
22. J. M. Ávila-Ruiz et al., “Frequency locked loop architecture for phase noise reduction in wideband low-noise microwave oscillators,” IET Microwaves, Antennas & Propagation 7(11), 869-875 (2013).
23. L. Zhang et al., “Self-ilpll using optical feedback for phase noise reduction in microwave oscillators,” IEEE Photonics Technol. Lett. 27(6), 624-627 (2015).
24. T. Sun et al., “Oscillator phase noise redu-ction using optical feedback with dual drive mach zehnder modulator,” in IEEE MTT-S Int. Microwave Symp., pp. 1-3, IEEE, (2015).
25. X. C. Wang et al., “Ultra-low phase noise measurement of microwave sources using carrier suppression enabled by a photonic delay line,” J. Lightwave Technol. 39(22), 7028-7039 (2021).
26. E. Rubiola et al., “Very high frequency and microwave interferometric phase and amplitude noise measurements,” Rev. Sci. Instrum. 70(1), 220-225 (1999).
27. E. Rubiola and V. Giordano, “A low-flicker scheme for the real-time measure-ment of phase noise,” IEEE Trans. Ultrason. Ferroelectr. Freq. Control 49(4), 501-507 (2002).
28. X. S. Yao et al., “Optoelectronic oscillator-incorporating carrier suppression noise,” in Proc. 1999 Joint Meet. Eur. Freq. Time Forum and IEEE Int. Freq. Control Symp, pp. 565-566, IEEE, (1999).
29. L. Maleki et al., “New schemes for improved opto-electronic oscillator,” in Proc. Int. Top. Meet. Microwave Photonics. MWP′99. Tech. Dig, pp. 177-180, IEEE, (1999).
30. X. S. Yao and L. Maleki, “Multiloop optoelectronic oscillator,” IEEE J. Quantum Electron. 36(1), 79-84 (2000).
31. Y. Qiao et al., “Parity-time-symmetric optoelectronic oscillator based on higher-order optical modulation,” Opt. Lett. 47(17), 4383-4386 (2022).
32. H. Liu et al., “Ultra-high-efficiency dual-band thin-film lithium niobate modulator incorporating low-k underfill with 220 ghz extrapolated bandwidth for 390 gbit/s pam8 transmission,” arXiv preprint arXiv:2411.15037 (2024).
33. J. Tang et al., “Integrated optoelectronic oscillator,” Opt. Express 26(9), 12257-12265 (2018).
34. G. Zhang et al., “Hybrid-integrated wideband tunable optoelectronic oscillator,” Opt. Express 31(10), 16929-16938 (2023).
35. R. Ma et al., “Ka-band thin film lithium niobate photonic integrated optoelectronic oscillator,” Photonics Res. 12(6), 1283-1293 (2024).
36. R. Ma et al., “Widely tunable ka-band optoelectronic oscillator integrated on thin film lithium niobate platform,” APL Photonics 9(9) (2024).
37. M. Xu et al., “High-performance coherent optical modulators based on thin-film lithium niobate platform,” Nat. Commun. 11(1), 3911 (2020).
38. M. He et al., “High-performance hybrid silicon and lithium niobate mach-zehnder modulators for 100 gbit s−1 and beyond,” Nat. Photonics 13(5), 359-364 (2019).
39. P. Ying et al., “Low-loss edge-coupling thin-film lithium niobate modulator with an efficient phase shifter,” Opt. Lett. 46(6), 1478-1481 (2021).
40. M.-J. Li et al., “Reduced coating diameter fibers for high density optical interconnects,” J. Lightwave Technol. 41(3), 999-1009 (2022).

What is claimed is:

1. A device, comprising:
a voltage controlled oscillator that includes a first input port to receive a control voltage that controls the voltage controlled oscillator, a second input port to receive an injection oscillation signal, and an output port to output an oscillation signal at a carrier oscillation frequency in response to the control voltage and the injection oscillation signal;
an optical modulator coupled to receive the oscillation signal from the voltage controlled oscillator to modulate light at the carrier oscillation frequency to produce modulated light;
an optical delay element coupled to receive a first portion of the modulated light from the optical modulator to output a first optical signal with a long delay caused by the optical delay element;
a first optical detector coupled to receive the first optical signal output by the optical delay element to produce a first electrical signal;
a second optical detector coupled to receive a second portion of the modulated light from the optical modulator that does not pass through the optical delay element, as a second optical signal to produce a second electrical signal;
an electrical interferometer coupled to receive the first and second electrical signals to cause an interference between the first and second electrical signals to produce a first electrical interferometer output signal representing a destructive interference that suppresses signaling at the carrier oscillation frequency and a second electrical interferometer output signal representing a constructive interference;
a signal mixer coupled to receive the first electrical interferometer output signal representing the destructive interference and the second electrical interferometer output signal representing the constructive interference to output a first feedback signal with an amplitude representing a phase noise of the carrier oscillation signal output by the voltage controlled oscillator with suppression of signaling at the carrier oscillation frequency;
a first feedback loop coupled between the signal mixer and the first input port of the voltage controlled oscillator to receive the first feedback signal to generate the control voltage and to couple the control voltage to the first input port of the voltage controlled oscillator so as to reduce the phase noise in the carrier oscillation signal output by the voltage controlled oscillator;
an electrical signal coupler coupled between the electrical interferometer and the signal mixer to split a portion of the second electrical interferometer output signal representing the constructive interference as a second feedback signal; and
a second feedback loop coupled between the electrical signal coupler and the second input port of the voltage controlled oscillator to receive the second feedback signal to produce the injection oscillation signal that causes the voltage controlled oscillator to lock the carrier oscillation frequency at a frequency that maximizes an amplitude of the second electrical interferometer output signal representing the constructive interference to further reduce the phase noise in the carrier oscillation signal output by the voltage controlled oscillator.

2. The device as in claim 1, wherein the optical delay element includes optical fiber.

3. The device as in claim 1, wherein the optical delay element includes an optical resonator.

4. The device as in claim 1, further comprising a phase shifter in a path of the first or second optical signal to change a relative phase between the first and second optical signals.

5. The device as in claim 1, further comprising a signal attenuator in a path of the first or second optical signal to change an amplitude of the first or second optical signal.

6. The device as in claim 1, further comprising an electrical signal amplifier in a path of the first electrical interferometer output signal or the second electrical interferometer output signal.

7. The device as in claim 1, wherein the first feedback loop coupled between the signal mixer and the first input port of the voltage controlled oscillator includes a low pass filter that removes high frequency signal components in the first feedback signal output by the signal mixer in generating the control voltage to the first input port of the voltage controlled oscillator so as to reduce the phase noise in the carrier oscillation signal output by the voltage controlled oscillator.

8. The device as in claim 1, further comprising a laser that produces laser light as light received and modulated by the optical modulator.

9. The device as in claim 1, comprising an RF phase shifter placed between the signal mixer and one of the electrical interferometer output ports to control a relative phase between the first and second electrical interferometer output signals representing to be around 0 or 180 degrees.

10. The device as in claim 1, further comprising a low noise amplifier placed at at least one of the first and second electrical interferometer output ports to amplify a corresponding signal.

11. The device as in claim 1, further comprising a control circuit that closes the first and second feedback loop at different times.

12. A device that is separate from a voltage controlled oscillator and can be coupled to the voltage controlled oscillator to control an oscillation signal at a carrier oscillation frequency generated by the voltage controlled oscillator, comprising:
a light source that produces light;
an optical modulator coupled to receive the oscillation signal at the carrier oscillation frequency generated by the voltage controlled oscillator to modulate light at the carrier oscillation frequency to produce modulated light;
an optical delay element coupled to receive a first portion of the modulated light from the optical modulator to output a first optical signal with a long delay caused by the optical delay element;
a first optical detector coupled to receive the first optical signal output by the optical delay element to produce a first electrical signal;
a second optical detector coupled to receive a second portion of the modulated light from the optical modulator, without the delay or with a short delay caused by the optical delay element, as a second optical signal to produce a second electrical signal;
an electrical interferometer coupled to receive the first and second electrical signals to cause an interference between the first and second electrical signals to produce a first electrical interferometer output signal representing a destructive interference that suppresses signaling at the carrier oscillation frequency and a second electrical interferometer output signal representing a constructive interference;
a signal mixer coupled to receive the first electrical interferometer output signal representing the destructive interference and the second electrical interferometer output signal representing the constructive interference to output a first feedback signal with an amplitude representing a phase noise of the carrier oscillation signal output by the voltage controlled oscillator with suppression of signaling at the carrier oscillation frequency;
a first electrical device output port coupled to receive the first feedback signal from the signal mixer to generate an output control voltage for controlling the voltage controlled oscillator;
an electrical signal coupler between the electrical interferometer and the signal mixer to split a portion of the second electrical interferometer output signal representing the constructive interference output as a second feedback signal;
a second electrical device output port coupled to receive the second feedback signal from the electrical signal coupler to produce an output injection oscillation signal for injecting locking the voltage controlled oscillator; and
an electrical device input port operable to be coupled to receive the oscillation signal generated by the voltage controlled oscillator and coupled to deliver the received oscillation signal generated by the voltage controlled oscillator to the optical modulator for modulating the light.

13. The device as in claim 12, further comprising a low pass filter coupled between the signal mixer and the first electrical device output port to receive the first feedback signal from the signal mixer to generate the output control voltage by removing high frequency signal components in the first feedback signal in generating the control voltage.

14. The device as in claim 12, comprising an RF phase shifter placed between the signal mixer and one of the electrical interferometer output ports to control a relative phase between the first and second electrical interferometer output signals representing to be around 0 or 180 degrees.

15. The device as in claim 12, further comprising a low noise amplifier placed at at least one of the first and second electrical interferometer output ports to amplify a corresponding signal.

16. A device that is separate from an opto-electronic oscillator includes a loop having an optical loop section and an electrical loop section coupled to each other via a photodetector that converts light in the optical loop section into an electrical signal carried by the electrical loop section, and can be coupled to the an opto-electronic oscillator to control an oscillation signal at a carrier oscillation frequency generated by the opto-electronic oscillator, comprising:
an optical input port to receive input light from the optical loop section of the opto-electronic oscillator;
an optical splitter coupled to the optical input port to split the input light into a first input light signal and a second input light signal;
an optical delay element coupled to receive the first input light signal to output a first optical signal with a long delay caused by the optical delay element;
a first optical detector coupled to receive the first optical signal output by the optical delay element to produce a first electrical signal;
a second optical detector coupled to receive the second input light signal, without the delay or with a short delay caused by the optical delay element to produce a second electrical signal;
an electrical interferometer coupled to receive the first and second electrical signals to cause an interference between the first and second electrical signals to produce a first electrical interferometer output signal representing a destructive interference that suppresses signaling at the carrier oscillation frequency and a second electrical interferometer output signal representing a constructive interference;
a signal mixer coupled to receive the first electrical interferometer output signal representing the destructive interference and the second electrical interferometer output signal representing the constructive interference to output a first feedback signal;
a first electrical device output port coupled to receive the first feedback signal from the signal mixer to generate an output control voltage that is intended for being applied to modulation of light in the optical loop section of the loop of the opto-electronic oscillator;
an electrical signal coupler between the electrical interferometer and the signal mixer to split a portion of the second electrical interferometer output signal representing the constructive interference as a second feedback signal; and
a second electrical device output port coupled to receive the second feedback signal from the electrical signal coupler to produce an output injection oscillation signal that is intended for being injected into the electrical loop section of the loop of the opto-electronic oscillator.

17. The device as in claim 16, comprising an RF phase shifter placed between the signal mixer and one of the electrical interferometer output ports to control a relative phase between the first and second electrical interferometer output signals representing to be around 0 or 180 degrees.

18. The device as in claim 16, further comprising a low noise amplifier placed at at least one of the first and second electrical interferometer output ports to amplify a corresponding signal.

19. A device, comprising:
an opto-electronic oscillator (OEO) structured to include an OEO electrical output port that outputs an electrical oscillation signal at a carrier oscillation frequency, an OEO electrical injection input port to receive an electrical injection signal, an OEO electrical voltage input port to receive an electrical voltage signal, and an OEO optical output port to output an OEO optical signal; and
an OEO control module coupled to the OEO and structured to include
an optical input port coupled to receive the OEO optical signal from the OEO as input light, an optical splitter coupled to the optical input port to split the input light into a first input light signal and a second input light signal,
an optical delay element coupled to receive the first input light signal to output a first optical signal with a delay caused by the optical delay element,
a first optical detector coupled to receive the first optical signal output by the optical delay element to produce a first electrical signal,
a second optical detector coupled to receive the second input light signal that does not pass through the optical delay element to produce a second electrical signal,
an electrical interferometer coupled to receive the first and second electrical signals to cause an interference between the first and second electrical signals to produce a first electrical interferometer output signal representing a destructive interference that suppresses signaling at the carrier oscillation frequency and a second electrical interferometer output signal representing a constructive interference,
a signal mixer coupled to receive the first electrical interferometer output signal representing the destructive interference and the second electrical interferometer output signal representing the constructive interference to output a first feedback signal,
a first electrical device output port coupled to receive the first feedback signal from the signal mixer to generate an output control voltage that is coupled to the OEO electrical voltage input port as the electrical voltage signal to the OEO,
an electrical signal coupler coupled between the electrical interferometer and the signal mixer to split a portion of the second electrical interferometer output signal representing the constructive interference as a second feedback signal, and
a second electrical device output port coupled to receive the second feedback signal from the electrical signal coupler to produce an output injection oscillation signal that is coupled to the OEO electrical injection input port as the electrical injection signal to the OEO,
wherein the OEO further includes
an electric-optical modulator operable to generate a modulated optical signal as the OEO optical signal at the OEO optical output port based on an optical modulation in response to the electrical injection signal received at the OEO electrical injection input port and the electrical voltage signal received at the OEO electrical injection input port,
a photodetector coupled to receive a portion of output light from the electric-optical modulator and operable to convert the received portion of output light from the electric-optical modulator to a photodetector electrical signal, and
an electrical loop section coupled to receive the photodetector electrical signal, coupled to the OEO electrical voltage input port to receive the electrical voltage signal from the first electrical device output port, and coupled to the OEO electrical injection input port to receive the electrical injection signal from the second electrical device output port such that the electric-optical modulator, the photodetector, and the electrical loop section form an opto-electrical loop to sustain the electrical oscillation signal at the carrier oscillation frequency.

20. The device as in claim 19, wherein the OEO is a coupled OEO that includes an optical section that exhibits an optical gain to produce laser light that is modulated by the electric-optical modulator.

21. The device as in claim 19, comprising an RF phase shifter placed between the signal mixer and one of the electrical interferometer output ports to control a relative phase between the first and second electrical interferometer output signals representing to be around 0 or 180 degrees.

22. The device as in claim 19, further comprising a low noise amplifier placed at at least one of the first and second electrical interferometer output ports to amplify a corresponding signal.
